(19) United States
(12) Patent Application Publication
(10) Pub. No.: US 2025/0259779 A1
(43) Pub. Date: Aug. 14, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Tsuyoshi TAKAMATSU, Nagaokakyo-shi (JP); Hideki KAMO, Nagaokakyo-shi (JP); Katsufumi SASAKI, Nagaokakyo-shi (JP)

(73) Assignee: Murata Manufacturing Co., Ltd., Kyoto-fu (JP)

(21) Appl. No.: 19/196,347

(22) Filed: May 1, 2025

Related U.S. Application Data
(63) Continuation of application No. PCT/JP2023/030126, filed on Aug. 22, 2023.

(30) Foreign Application Priority Data
Nov. 2, 2022 (JP) 2022-176447

(51) Int. Cl. H01F 27/28; H01F 17/00

(52) U.S. Cl. CPC H01F 27/2828; H01F 17/00

(57) ABSTRACT

An inductor component includes an element body having first and second principal surfaces opposite to each other; a coil that is in the element body and is wound in a spiral shape along an axis; and first and second external electrodes that are on the element body and electrically connected to the coil. The axis of the coil is parallel to the first principal surface. The coil includes first coil wirings which are on the first principal surface side with respect to the axis and are arranged along the axis on a plane parallel to the first principal surface, second coil wirings which are on the second principal surface side with respect to the axis and are arranged along the axis on a plane parallel to the second principal surface, and first penetration wirings which extend from the respective first coil wirings toward the respective second coil wirings.

### CROSS-REFERENCE TO RELATED APPLICATION

This application claims benefit of priority to International Patent Application No. PCT/JP2023/030126, filed Aug. 22, 2023, and to Japanese Patent Application 2022-176447, filed Nov. 2, 2022, the entire contents of each are incorporated herein by reference.

### BACKGROUND

### Technical Field

The present disclosure relates to an inductor component.

### Background Art

Conventionally, as an inductor component, there is an inductor component described in Japanese Patent No. 6652280. The inductor component includes an element body, a coil that is provided in the element body and is wound along an axial direction, and a first external electrode and a second external electrode that are provided on the element body and are electrically connected to the coil.

The coil has a plurality of coil patterns layered along an axis. The coil patterns adjacent to each other in the axial direction are connected via a conductive via. Each coil pattern includes a wiring portion extending in a direction orthogonal to the axis and a pad portion that is provided at an end portion of the wiring portion and is connected to the conductive via. A width of the pad portion is wider than a width of the wiring portion in order to improve the connectivity between the pad portion and the conductive via.

### SUMMARY

Incidentally, in the conventional inductor component, since the width of the pad portion is wider than the width of the wiring portion, a part of the pad portion is positioned on an inner side in a radial direction of the coil with respect to the wiring portion. Therefore, an inner diameter of the coil becomes small, and the efficiency of acquisition of inductance is not necessarily high.

In this regard, the present disclosure provides an inductor component capable of increasing the efficiency of acquisition of inductance.

Accordingly, one aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. At least one of the plurality of first coil wirings and the plurality of second coil wirings is a bent wiring including a first part and a second part having different angles from each other with respect to the axis when viewed in a direction orthogonal to the first principal surface.

Here, the angle of the first part with respect to the axis indicates an angle formed by a center line (or an extension line of the center line) of the first part and the axis. For example, in a case where the center line intersects the axis, the angle formed by the center line and the axis indicates a smaller angle of intersection angles formed by the center line and the axis. In a case where the center line and the axis are parallel to each other, the angle formed by the center line and the axis is set to 0°. The same applies to the second part.

That “the external electrode is provided on the element body” specifically indicates that the external electrode is provided on an outer surface side of the element body. For example, this includes a case where the external electrode is provided immediately on an outer surface of the element body, a case where the external electrode is provided on an outer side of the element body via an additional member on the element body, and a case where the external electrode is provided on the outer surface of the external electrode in a state where a part of the external electrode is embedded in the element body.

According to the aspect, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance.

Further, since at least one of the plurality of first coil wirings and the plurality of second coil wirings is the bent wiring including the first part and the second part having different angles from each other with respect to the axis, a length of the wirings of the coil can be changed without changing a size of the inductor component such that the inductance can be easily adjusted.

Preferably, in an embodiment of the inductor component, the first part is a part orthogonal to the axis or a part parallel to the axis, and the second part is a part intersecting the axis at an acute angle, when viewed in the direction orthogonal to the first principal surface.

According to the embodiment, a length of the bent wirings can be easily increased.

Preferably, in the embodiment of the inductor component, the element body contains SiO₂.

According to the embodiment, it is possible to impart insulation properties and stiffness to the element body.

Preferably, in the embodiment of the inductor component, in the two bent wirings adjacent to each other in the axial direction, a distance between the second part of one of the bent wirings and the second part of the other of the bent wirings is smaller than a distance between the first part of one of the bent wirings and the first part of the other of the bent wirings, when viewed in the direction orthogonal to the first principal surface.

Here, the distance between the two second parts indicates a shortest distance between the two second parts when viewed in the direction orthogonal to the first principal surface. The same applies to the first part.

According to the embodiment, since the distance between the two second parts adjacent to each other in the axial direction is short, it is possible to reduce leakage flux.

Preferably, in the embodiment of the inductor component, the bent wirings are provided in at least the first coil wirings, and at least one second coil wiring of the plurality of second coil wirings extends in a direction in which centers of each of the first penetration wirings and each of the second penetration wirings connected to the same second coil wiring are connected by a straight line when viewed in the direction orthogonal to the first principal surface.

According to the embodiment, a length of the second coil wirings can be easily shortened.

Preferably, in the embodiment of the inductor component, the bent wirings are provided in at least the first coil wirings, one first coil wiring of the plurality of first coil wirings has a first end portion connected to the first external electrode and a second end portion connected to the first penetration wiring, and the one first coil wiring extends in a direction in which the first end portion and the second end portion are connected by a straight line when viewed in the direction orthogonal to the first principal surface.

According to the embodiment, a length of the first coil wiring constituting the outermost turn in the axial direction can be shortened, DC resistance of the coil can be reduced, and the coil can have a small size.

Preferably, in the embodiment of the inductor component, the first part is a part orthogonal to the axis when viewed in the direction orthogonal to the first principal surface, and a length of the first part is smaller than a half of a width of the element body in a direction orthogonal to the axis when viewed in the direction orthogonal to the first principal surface.

According to the embodiment, it is possible to reduce a likelihood that two bent wirings adjacent to each other in the axial direction will come into contact with each other.

Preferably, in the embodiment of the inductor component, the first part is a part orthogonal to the axis, and the second part is a part intersecting the axis at an acute angle, when viewed in the direction orthogonal to the first principal surface, and a width of the second part is 0.5 times or more and 0.95 times or less (i.e., from 0.5 times to 0.95 times) of a width of the first part when viewed in the direction orthogonal to the first principal surface.

According to the embodiment, since the width of the second part is 0.95 times or less of the width of the first part, the width of the second part can be decreased, and this enables the length of the second part to be increased so that the inductance can be increased. In addition, since the width of the second part is 0.5 times or more of the width of the first part, breakage of the second part can be prevented.

Preferably, in the embodiment of the inductor component, a shape of the coil has 180° rotational symmetry around a center of the coil in an axial direction when viewed in the direction orthogonal to the first principal surface.

According to the embodiment, directionality of the inductor component can be eliminated.

Preferably, in the embodiment of the inductor component, a length of each of the bent wirings between centers of each of the first penetration wirings and each of the second penetration wirings connected to each of the bent wirings is longer by 4% or more of a length obtained by connecting centers of each of the first penetration wirings and each of the second penetration wirings connected to the same bent wiring by a straight line, when viewed in the direction orthogonal to the first principal surface.

According to the embodiment, since the lengths of the bent wirings can be increased, the inductance can be increased.

Preferably, in the embodiment of the inductor component, the first part is a part orthogonal to the axis, and the second part is a part intersecting the axis at an acute angle. Also, when viewed in the direction orthogonal to the first principal surface, and when an angle of the second part with respect to the axis is defined as a first angle θ1, and with respect to the axis, an angle of a straight line connecting centers of each of the first penetration wirings and each of the second penetration wirings connected to each of the bent wirings having the same second part is defined as a second angle θ2. When viewed in the direction orthogonal to the first principal surface, the second angle θ2 is larger than the first angle θ1, the first angle θ1 is larger than 45° and smaller than 80° (i.e., from larger than 45° to smaller than) 80°, and a difference between the second angle θ2 and the first angle θ1 is larger than 1° and smaller than 45° (i.e., from larger than 1° to smaller than) 45°.

According to the embodiment, since the first angle θ1 is larger than 45°, the width of the second part can be ensured, and the efficiency of acquisition of inductance can be ensured. Since the first angle θ1 is smaller than 80°, the length of the second part can be increased, and the inductance can be improved.

Since the difference between the second angle θ2 and the first angle θ1 is larger than 1°, the length of the second part can be increased, and the inductance can be improved. Since the difference between the second angle θ2 and the first angle θ1 is smaller than 45°, the width of the second part can be ensured.

Preferably, in the embodiment of the inductor component, the bent wirings are provided in at least the first coil wirings, an outermost first coil wiring positioned on an outermost side in the axial direction of the plurality of first coil wirings is not one of the bent wirings, and a maximum length in the axial direction of the outermost first coil wiring is larger than a maximum length in the axial direction of one of the first coil wirings which is adjacent to the outermost first coil wiring in the axial direction when viewed in the direction orthogonal to the first principal surface.

According to the embodiment, a width of the first coil wiring at the outermost end can be increased such that the DC resistance of the coil can be reduced. In addition, the width of the first coil wiring at the outermost end can be increased by effectively utilizing a dead space in an outermost region of the coil in the axial direction in the element body.

Preferably, another embodiment of the inductor component comprises: an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. At least one of the plurality of first coil wirings and the plurality of second coil wirings is a bent wiring including a curved part, when viewed in a direction orthogonal to the first principal surface.

According to the embodiment, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance.

Further, since at least one of the plurality of first coil wirings and the plurality of second coil wirings is the bent wiring including the curved part, a length of the wirings of the coil can be changed without changing a size of the inductor component such that the inductance can be easily adjusted.

Preferably, in the embodiment of the inductor component, a plurality of the bent wirings are present, and all the curved parts are curved to project toward one side in the axial direction when viewed in the direction orthogonal to the first principal surface.

According to the embodiment, since all the curved parts are curved to project to one side in the axial direction, a reverse magnetic field is not generated in all the curved parts such that the efficiency of acquisition of the inductor can be increased.

Preferably, in the embodiment of the inductor component, a side surface of each of the curved parts has a recess when viewed from the direction orthogonal to the first principal surface.

According to the embodiment, since the side surface of each of the curved parts has the recess, the width of the curved parts can be decreased such that it is possible to decrease a likelihood that two bent wirings adjacent to each other in the axial direction will come into contact with each other.

Preferably, in the embodiment of the inductor component, the bent wirings have only the respective curved parts.

According to the embodiment, since each of the bent wirings does not have a straight part, the length of the coil can be further increased.

According to the inductor component which is the one aspect of the present disclosure, it is possible to increase the efficiency of acquisition of inductance.

### BRIEF DESCRIPTION OF THE DRAWINGS

FIG. 1 is a schematic bottom view of an inductor component from a bottom surface side according to a first embodiment;

FIG. 2 is a cross-sectional view taken along line II-II in FIG. 1;

FIG. 3 is a cross-sectional view taken along line III-III in FIG. 1;

FIG. 4A is a schematic bottom view of a bottom surface wiring from the bottom surface side;

FIG. 4B is a schematic bottom view of a top surface wiring from the bottom surface side;

FIG. 5A is a schematic cross-sectional view illustrating a method for manufacturing an inductor component;

FIG. 5B is a schematic cross-sectional view illustrating the method for manufacturing an inductor component;

FIG. 5C is a schematic cross-sectional view illustrating the method for manufacturing an inductor component;

FIG. 5D is a schematic cross-sectional view for illustrating the method for manufacturing an inductor component;

FIG. 5E is a schematic cross-sectional view illustrating the method for manufacturing an inductor component;

FIG. 5F is a schematic cross-sectional view illustrating the method for manufacturing an inductor component;

FIG. 5G is a schematic cross-sectional view illustrating the method for manufacturing an inductor component;

FIG. 5H is a schematic cross-sectional view illustrating the method for manufacturing an inductor component;

FIG. 5I is a schematic cross-sectional view illustrating the method for manufacturing an inductor component;

FIG. 5J is a schematic cross-sectional view illustrating the method for manufacturing an inductor component;

FIG. 5K is a schematic cross-sectional view illustrating the method for manufacturing an inductor component;

FIG. 5L is a schematic cross-sectional view illustrating the method for manufacturing an inductor component;

FIG. 5M is a schematic cross-sectional view illustrating the method for manufacturing an inductor component;

FIG. 6A is a cross-sectional view showing a first modification example of the inductor component;

FIG. 6B is a cross-sectional view showing a second modification example of the inductor component;

FIG. 6C is a cross-sectional view showing a third modification example of the inductor component;

FIG. 6D is a cross-sectional view showing a fourth modification example of the inductor component;

FIG. 7A is a schematic bottom view of a bottom surface wiring from the bottom surface side according to a fifth modification example of the inductor component;

FIG. 7B is a schematic bottom view of a top surface wiring from the bottom surface side according to the fifth modification example of the inductor component;

FIG. 8 is a schematic bottom view of an inductor component from a bottom surface side according to a second embodiment;

FIG. 9 is a cross-sectional view taken along line IX-IX in FIG. 8;

FIG. 10 is a schematic bottom view of the top surface wiring from the bottom surface side;

FIG. 11A is a schematic cross-sectional view illustrating a method for manufacturing the inductor component;

FIG. 11B is a schematic cross-sectional view illustrating the method for manufacturing an inductor component;

FIG. 11C is a schematic cross-sectional view illustrating the method for manufacturing an inductor component;

FIG. 11D is a schematic cross-sectional view illustrating the method for manufacturing an inductor component;

FIG. 11E is a schematic cross-sectional view illustrating the method for manufacturing an inductor component;

FIG. 11F is a schematic cross-sectional view illustrating the method for manufacturing an inductor component;

FIG. 11G is a schematic cross-sectional view illustrating the method for manufacturing an inductor component;

FIG. 11H is a schematic cross-sectional view illustrating the method for manufacturing an inductor component;

FIG. 12A is a cross-sectional view showing a first modification example of the inductor component;

FIG. 12B is a cross-sectional view showing a second modification example of the inductor component;

FIG. 12C is a cross-sectional view showing a third modification example of the inductor component;

FIG. 13 is a schematic bottom view of an inductor component from a bottom surface side according to a third embodiment; and

FIG. 14 is a schematic bottom view of a top surface wiring of an inductor component from a bottom surface side according to a fourth embodiment.

### DETAILED DESCRIPTION

Hereinafter, an inductor component which is the one aspect of the present disclosure will be described in detail with reference to embodiments shown in the drawings. Note that the drawings include some schematic drawings, and may not reflect actual dimensions and ratios.

### First Embodiment

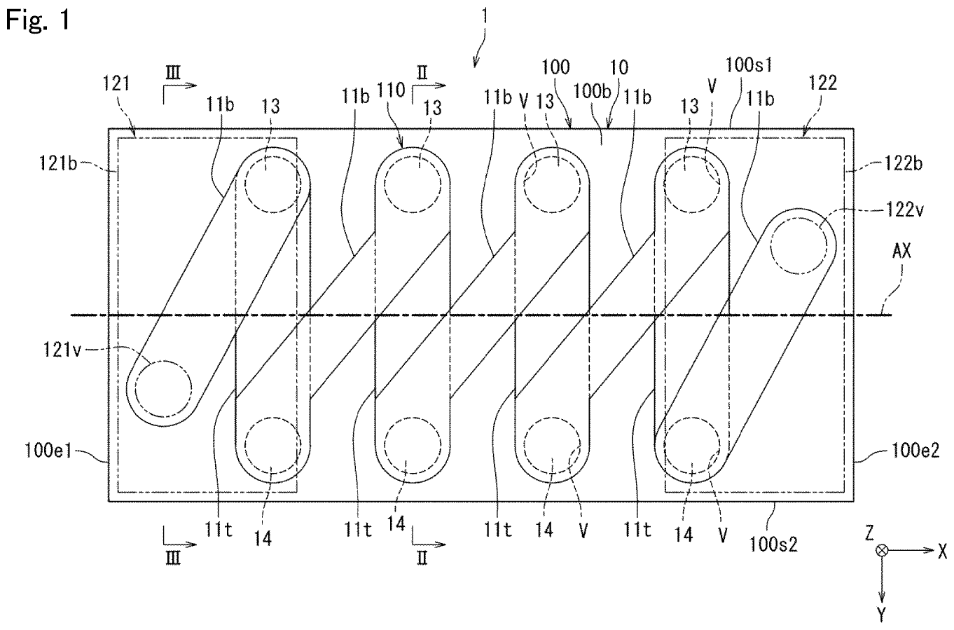

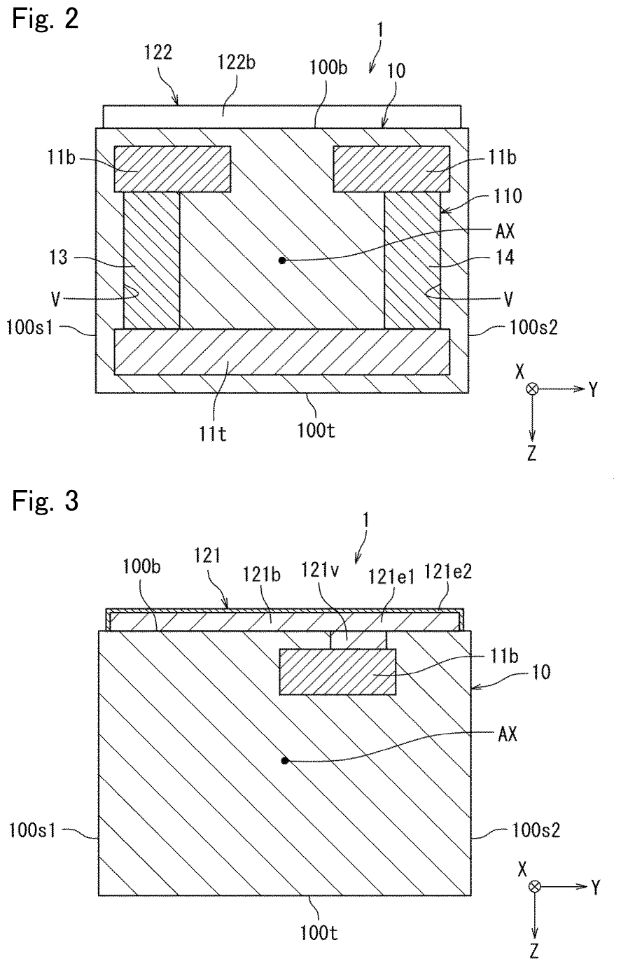

An inductor component 1 according to the first embodiment will be described below. FIG. 1 shows a schematic bottom view of the inductor component 1 from a bottom surface side thereof. FIG. 2 is a cross-sectional view taken along line II-II in FIG. 1. FIG. 3 is a cross-sectional view taken along line III-III in FIG. 1. Note that, in FIG. 1, an external electrode is drawn by a two-dot chain line for convenience. In addition, in FIG. 1, an element body 10 is drawn transparently so that a structure thereof can be easily understood, but may be translucent or opaque.

### 1. GENERAL CONFIGURATION

A general configuration of the inductor component 1 will be described. The inductor component 1 is, for example, a surface mount inductor component that is used in a high-frequency signal transmission circuit. As shown in FIGS. 1, 2, and 3, the inductor component 1 includes the element body 10, a coil 110 that is provided in the element body 10 and is wound in a spiral shape along an axis AX, and a first external electrode 121 and a second external electrode 122 that are provided on the element body 10 and are electrically connected to the coil 110.

The element body 10 has a length, a width, and a height. The element body 10 has a first end surface 100e1 and a second end surface 100e2 on both end sides in a length direction, a first side surface 100s1 and a second side surface 100s2 on both end sides in a width direction, and a bottom surface 100b and a top surface 100t on both end sides in a height direction. That is, outer surfaces 100 of the element body 10 include the first end surface 100e1 and the second end surface 100e2, the first side surface 100s1 and the second side surface 100s2, and the bottom surface 100b and the top surface 100t. The bottom surface 100b corresponds to an example of a “first principal surface” described in CLAIMS, and the top surface 100t corresponds to an example of a “second principal surface” described in CLAIMS.

As shown in the drawings, hereinafter, for convenience of description, a direction that is the length direction (longitudinal direction) of the element body 10 and is from the first end surface 100e1 toward the second end surface 100e2 is referred to as an X direction. In addition, a direction that is the width direction of the element body 10 and is from the first side surface 100s1 toward the second side surface 100s2 is referred to as a Y direction. In addition, a direction that is the height direction of the element body 10 and is from the bottom surface 100b toward the top surface 100t is referred to as a Z direction. The X direction, the Y direction, and the Z direction are directions orthogonal to each other and form a right-handed system when arranged in an order of X, Y, and Z.

In this specification, the “outer surfaces 100 of the element body” including the first end surface 100e1, the second end surface 100e2, the first side surface 100s1, the second side surface 100s2, the bottom surface 100b, and the top surface 100t of the element body 10 do not simply mean surfaces of the element body 10 toward the outer circumferential sides of the element body 10, but are surfaces serving as a boundary between an outside and an inside of the element body 10. In addition, “above the outer surfaces 100 of the element body 10” does not indicate an absolute direction such as a vertical upward direction defined in the direction of gravity, but indicates a direction toward the outside with the outer surfaces 100 as a reference, of the outside and inside with the outer surfaces 100 as the boundary therebetween. Hence, “above the outer surfaces 100” indicates a relative direction determined depending on an orientation of the outer surfaces 100. In addition, “above” with respect to a certain element means not only above from the corresponding element, that is, an upper position via another object on the corresponding element or an upper position apart from the corresponding element at an interval, but also a position immediately on the corresponding element to be in contact with the corresponding element.

The axis AX of the coil 110 is disposed parallel to the bottom surface 100b. The coil 110 includes a plurality of bottom surface wirings 11b which are provided on the bottom surface 100b side with respect to the axis AX and are arranged along the axis AX on a plane parallel to the bottom surface 100b, a plurality of top surface wirings 11t which are provided on the top surface 100t side with respect to the axis AX and are arranged along the axis AX on a plane parallel to the top surface 100t, a plurality of first penetration wirings 13 which extend from the respective bottom surface wirings 11b toward the respective top surface wirings 11t, and are arranged along the axis AX, and a plurality of second penetration wirings 14 which extend from the respective bottom surface wirings 11b toward the respective top surface wirings 11t, are provided on a side opposite to the respective first penetration wirings 13 with respect to the axis AX, and are arranged along the axis AX. Each of the bottom surface wirings 11b, each of the first penetration wirings 13, each of the top surface wirings 11t, and each of the second penetration wirings 14 form at least a part of a spiral shape by being connected in this order.

The bottom surface wiring 11b corresponds to an example of a “first coil wiring” described in CLAIMS, and the top surface wiring 11t corresponds to an example of a “second coil wiring” described in CLAIMS. The axis AX indicates an intersection line of a first plane passing through centers between the bottom surface wirings 11b and the top surface wirings 11t and a second plane passing through centers between the first penetration wirings 13 and the second penetration wirings 14. That is, the axis AX is a straight line passing through a center of an inner diameter portion of the coil 110. The axis AX of the coil 110 does not have a dimension in a direction orthogonal to the axis AX.

According to the configuration described above, since the coil 110 includes the bottom surface wirings 11b, the first penetration wirings 13, the top surface wirings 11t, and the second penetration wirings 14, and each of the bottom surface wirings 11b, each of the first penetration wirings 13, each of the top surface wirings 11t, and each of the second penetration wirings 14 form at least a part of the spiral shape by being connected in this order, it is possible to increase an inner diameter of the coil 110 such that it is possible to increase the efficiency of acquisition of inductance. In addition, a Q value can be increased by increasing the efficiency of acquisition of inductance.

To be more specific, since pad portions of a conventional inductor component or the bottom surface wirings 11b and the top surface wirings 11t of the present embodiment are “reception portions” of wirings (conductive vias of the conventional inductor component or the first penetration wirings 13 and the second penetration wirings 14 of the present embodiment) which penetrate an element body, the pad portions and the bottom and top surface wirings have a shape expanding perpendicularly to a direction in which to penetrate the element body. Here, in a configuration of the conventional inductor component, since the conductive vias extend in a direction parallel to an axis of a coil, the pad portions are expanded in a direction perpendicular to the axis of the coil and are likely to have a structure in which magnetic flux generated in an axial direction of the coil is blocked.

On the other hand, in the present embodiment, since the first penetration wiring 13 and the second penetration wiring 14 extend in a direction perpendicular to the axis AX of the coil 110, the bottom surface wiring 11b and the top surface wiring 11t are expanded in a direction parallel to the axis AX of the coil 110. Accordingly, it is difficult for the bottom surface wiring 11b and the top surface wiring 11t to have a structure in which magnetic flux generated in an axis AX direction is blocked. That is, according to the present embodiment, it is possible to have the structure in which it is difficult to block the magnetic flux such that it is possible to improve the efficiency of acquisition of inductance and the Q value.

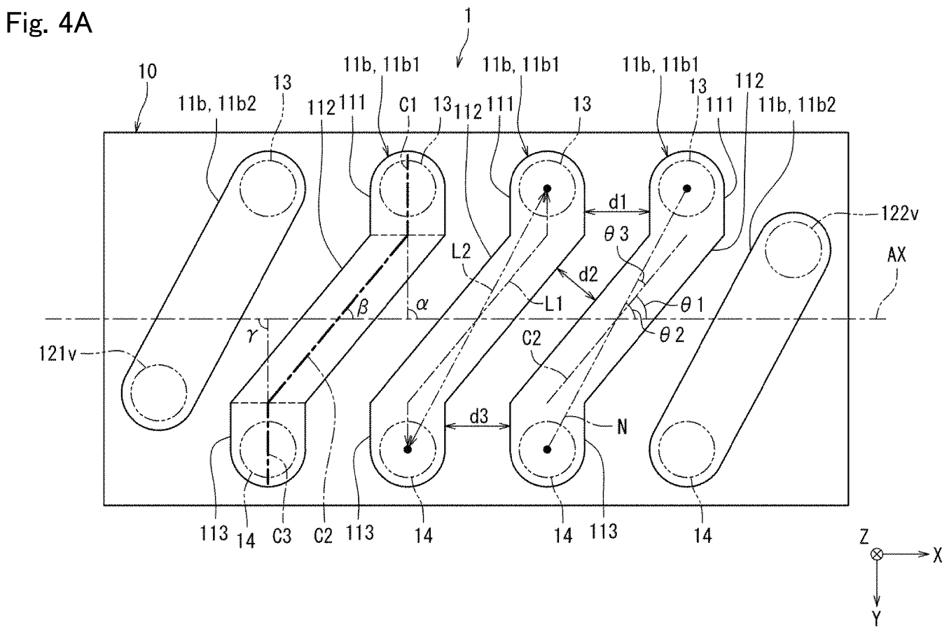

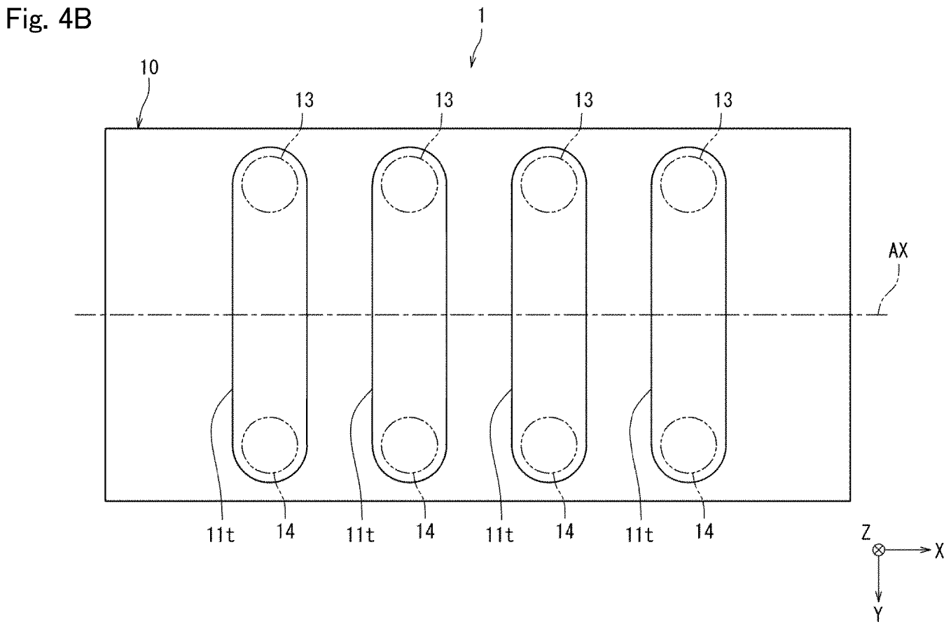

FIG. 4A is a schematic bottom view of the bottom surface wiring 11b from the bottom surface side. In FIG. 4A, for convenience, the first penetration wirings 13 and the second penetration wirings 14 are drawn by two-dot chain lines, and a via part 121v of the first external electrode 121 connected to the bottom surface wiring 11b and a via part 122v of the second external electrode 122 connected to the bottom surface wiring 11b are drawn by two-dot chain lines. In addition, the element body 10 is drawn transparently.

As shown in FIG. 4A, when viewed in a direction (Z direction) orthogonal to the bottom surface 100b, at least one bottom surface wiring 11b of the plurality of bottom surface wirings 11b is a bent wiring 11b1 having a first part 111 and a second part 112 having different angles from each other with respect to the axis AX. An angle of the first part 111 with respect to the axis AX is an angle α formed by the axis AX and an extension line of a first center line C1 in a width direction of the first part 111 when viewed in the direction orthogonal to the bottom surface 100b. An angle of the second part 112 with respect to the axis AX is an angle β formed by the axis AX and a second center line C2 in a width direction of the second part 112 when viewed in the direction orthogonal to the bottom surface 100b. The first center line C1 is parallel with an extending direction of the first part 111, and the second center line C2 is parallel with an extending direction of the second part 112. The first center line C1 and the second center line C2 are represented by a thick chain line.

According to the configuration described above, since at least one of the plurality of bottom surface wirings 11b is the bent wiring 11b1 including the first part 111 and the second part 112 having different angles from each other with respect to the axis AX, a length of the wirings of the coil 110 can be changed without changing a size of the inductor component 1 such that the inductance can be easily adjusted.

To be more specific, a length of the bent wiring 11b1 can be adjusted to be longer than that of a straight wiring connecting the first penetration wiring 13 and the second penetration wiring 14 at the shortest distance. As described above, adjustment of the length of the wirings of the coil 110 without changing the size of the inductor component 1 enables the inductance to be adjusted without changing the number of turns or a pitch of the penetration wiring. For example, an inductor suitable for impedance matching can be easily obtained. A length of the bottom surface wiring 11b (including the bent wiring 11b1) is a dimension in an extending direction of the bottom surface wiring 11b, and indicates a length of a center line of the bottom surface wiring 11b, when viewed in the direction orthogonal to the bottom surface 100b.

Note that, at least one of the plurality of top surface wirings 11t may be a bent wiring including a first part and a second part having different angles from each other with respect to the axis AX, and the length of the wirings of the coil 110 can be changed without changing the size of the inductor component 1 such that the inductance can be easily adjusted. In short, at least one of the plurality of bottom surface wirings 11b and the plurality of top surface wirings 11t may be a bent wiring.

### 2. CONFIGURATIONS OF RESPECTIVE UNITS

### (Inductor Component 1)

A volume of the inductor component 1 is 0.08 mm³ or smaller, and a size of a long side of the inductor component 1 is 0.65 mm or smaller. The size of the long side of the inductor component 1 indicates the largest value of a length, a width, and a height of the inductor component 1, and in this embodiment, indicates the length in the X direction. According to the configuration described above, since the volume of the inductor component 1 is small and the long side of the inductor component 1 is short, a weight of the inductor component 1 is reduced. Therefore, even if the external electrodes 121 and 122 are small, necessary mounting strength can be obtained. In addition, a thickness of the inductor component 1 is preferably 200 μm or smaller. This enables a thin inductor component 1 to be obtained.

To be more specific, the size (length (X direction)× width (Y direction)× height (Z direction)) of the inductor component 1 is 0.6 mm×0.3 mm×0.3 mm, 0.4 mm×0.2 mm×0.2 mm, 0.25 mm×0.125 mm×0.120 mm, or the like. In addition, the width and the height may not be equal, and may be, for example, 0.4 mm×0.2 mm×0.3 mm.

### (Element Body 10)

The element body 10 contains SiO₂. This enables insulation properties and stiffness to be imparted to the element body 10. The element body 10 is made of, for example, a glass sintered body. The glass sintered body may contain alumina, and the strength of the element body can be further increased.

The glass sintered body is formed by, for example, layering insulating layers containing a plurality of types of glass. A layering direction of the plurality of insulating layers is the Z direction. That is, the insulating layer has a layer shape having a principal surface expanding on an X-Y plane. Note that, in the element body 10, an interface between the plurality of insulating layers may not be distinct due to firing or the like.

Note that the element body 10 may include, for example, a glass substrate. The glass substrate may be a single-layer glass substrate, and since most of the element body is made of glass, it is possible to reduce a loss such as an eddy current loss at a high frequency.

### (Coil 110)

The coil 110 includes the plurality of bottom surface wirings 11b, the plurality of top surface wirings 11t, the plurality of first penetration wirings 13, and the plurality of second penetration wirings 14. The bottom surface wirings 11b, the first penetration wirings 13, the top surface wirings 11t, and the second penetration wirings 14 are connected in this order, respectively, to constitute at least a part of the coil 110 wound in the axis AX direction.

According to the configuration described above, since the coil 110 is a so-called helical coil 110, in a cross section orthogonal to the axis AX, it is possible to reduce a region where the bottom surface wiring 11b, the top surface wiring 11t, the first penetration wiring 13, and the second penetration wiring 14 are laid out parallel to each other in a winding direction of the coil 110, and it is possible to reduce stray capacitance in the coil 110.

Here, the helical shape indicates a shape in which the number of turns of the entire coil is more than one turn, and the number of turns of the coil in the cross section orthogonal to the axis is less than one turn. One or more turns indicate a state in which the wirings of the coil have, on the cross section orthogonal to the axis, parts that are adjacent to each other in a radial direction and are laid out parallel to each other in the winding direction when viewed in an axial direction, and less than one turn indicates a state in which the wirings of the coil does not have, on the cross section orthogonal to the axis, parts that are adjacent to each other in the radial direction and are laid out parallel to each other in the winding direction when viewed in the axial direction.

As shown in FIG. 4A, the plurality of bottom surface wirings 11b are arranged in the X direction. Each of the plurality of bottom surface wirings 11b includes a bent wiring 11b1 and straight wirings 11b2. The straight wirings 11b2 are disposed at both ends, respectively, in the axis AX direction. The bent wiring 11b1 is disposed between the straight wirings 11b2 at both ends.

One straight wiring 11b2 of both ends has a first end portion connected to the via part 121v of the first external electrode 121 and a second end portion connected to the first penetration wiring 13. One straight wiring 11b2 extends in a direction in which the first end portion and the second end portion are connected by a straight line when viewed in the direction orthogonal to the bottom surface 100b. This enables the length of the bottom surface wiring 11b (straight wiring 11b2) constituting the outermost turn in the axial direction to be shortened, enables the DC resistance of the coil 110 to be reduced, and enables the coil 110 to have a small size.

Similarly, the other straight wiring 11b2 of both ends has a first end portion connected to the via part 122v of the second external electrode 122 and a second end portion connected to the second penetration wiring 14. The other straight wiring 11b2 extends in a direction in which the first end portion and the second end portion are connected by a straight line when viewed in the direction orthogonal to the bottom surface 100b.

The bent wiring 11b1 has a first part 111, a second part 112, and a third part 113. The first part 111, the second part 112, and the third part 113 are connected in series in this order. In FIG. 4A, for convenience, in one bent wiring 11b1, a boundary line between the first part 111 and the second part 112 and a boundary line between the second part 112 and the third part 113 are represented by dotted lines.

When viewed in the direction orthogonal to the bottom surface 100b, the angle α of the first part 111 with respect to the axis AX is different from the angle β of the second part 112 with respect to the axis AX as described above. When viewed in the direction orthogonal to the bottom surface 100b, an angle γ of the third part 113 with respect to the axis AX is different from the angle β of the second part 112 with respect to the axis AX. The angle γ of the third part 113 with respect to the axis AX is an angle formed by the axis AX and an extension line of a third center line C3 of the third part 113 in a width direction thereof. The third center line C3 is parallel to an extending direction of the third part 113. The third center line C3 is represented by a thick chain line.

The first part 111 is a part orthogonal to the axis AX, that is, the angle α is 90°. The second part 112 is a part intersecting the axis AX at an acute angle, that is, the angle β is an acute angle. The third part 113 is a part orthogonal to the axis AX, that is, the angle γ is 90°. According to the configuration described above, the length of the bent wiring 11b1 can be easily increased. Note that the angle α may be different from the angle β, and the first part 111 may be a part parallel to the axis AX or a part intersecting the axis AX at an acute angle. In addition, the third part 113 may be a part parallel to the axis AX, or may be a part intersecting the axis AX at an acute angle, or may not be provided. In addition, the bent wiring 11b1 may further include another part in addition to the first part 111 to the third part 113.

Preferably, in the two bent wirings 11b1 adjacent to each other in the axis AX direction, when viewed in the direction orthogonal to the bottom surface 100b, a second distance d2 between a second part 112 of one bent wiring 11b1 and a second part 112 of the other bent wiring 11b1 is smaller than a first distance d1 between a first part 111 of one bent wiring 11b1 and a first part 111 of the other bent wiring 11b1. The second distance d2 indicates the shortest distance between the two second parts 112 when viewed in the direction orthogonal to the bottom surface 100b. The first distance d1 indicates the shortest distance between the two first parts 111 when viewed in the direction orthogonal to the bottom surface 100b. According to the configuration described above, since the second distance d2 is short, it is possible to reduce leakage flux. Similarly, the second distance d2 is preferably smaller than a third distance d3 between a third part 113 of one bent wiring 11b1 and a third part 113 of the other bent wiring 11b1.

Preferably, when viewed in the direction orthogonal to the bottom surface 100b, a length of the first part 111 is smaller than a half of a width of the element body 10 in a direction (Y direction) orthogonal to the axis AX. The length of the first part 111 is a length of the first center line C1 of the first part 111. According to the configuration described above, it is possible to reduce a likelihood that two bent wirings 11b1 adjacent to each other in the axis AX direction will come into contact with each other. Similarly, a length of the third part 113 is preferably smaller than a half of the width of the element body 10 in the direction orthogonal to the axis AX.

Preferably, when viewed in the direction orthogonal to the bottom surface 100b, a width of the second part 112 in a direction orthogonal to the second center line C2 is 0.5 times or more and 0.95 times or less (i.e., from 0.5 times to 0.95 times) of a width of the first part 111 in a direction orthogonal to the first center line C1. According to the configuration described above, since the width of the second part 112 is 0.95 times or less of the width of the first part 111, the width of the second part 112 can be decreased, and this enables a length of the second part 112 to be increased so that the inductance can be increased. In addition, since the width of the second part 112 is 0.5 times or more of the width of the first part 111, breakage of the second part 112 can be prevented. Similarly, when viewed in the direction orthogonal to the bottom surface 100b, preferably, the width of the second part 112 in the direction orthogonal to the second center line C2 is 0.5 times or more and 0.95 times or less (i.e., from 0.5 times to 0.95 times) of the width of the third part 113 in a direction orthogonal to the third center line C3.

Preferably, when viewed in the direction orthogonal to the bottom surface 100b, a first length L1 of the bent wiring 11b1 between centers of both the first penetration wiring 13 and the second penetration wiring 14 connected to the bent wiring 11b1 is longer by 4% or more of a second length L2 obtained by connecting centers of both the first penetration wiring 13 and the second penetration wiring 14 connected to the same bent wiring 11b1 by a straight line. In FIG. 4A, the first length L1 is represented by a chain line, and the second length L2 is represented by a two-dot chain line. The first length L1 is a length between the centers of both the first penetration wiring 13 and the second penetration wiring 14 of lengths of center lines (the first center line C1, the second center line C2, and the third center line C3) of the bent wiring 11b1. According to the configuration described above, since the length of the bent wiring 11b1 can be increased, the inductance can be increased.

Preferably, when viewed in the direction orthogonal to the bottom surface 100b, the angle β of the second part 112 (second center line C2) with respect to the axis AX is set to a first angle θ1, and an angle of a straight line N connecting centers of both the first penetration wiring 13 and the second penetration wiring 14 connected to the bent wiring 11b1 having the same second part 112, with respect to the axis AX, is set to a second angle θ2. In this case, the second angle θ2 is larger than the first angle θ1. The first angle θ1 is larger than 45° and smaller than 80° (i.e., from larger than 45° to smaller than) 80°. A third angle θ3, which is a difference between the second angle θ2 and the first angle θ1, is larger than 1° and smaller than 45° (i.e., from larger than 1° to smaller than) 45°.

According to the configuration described above, since the first angle θ1 is larger than 45°, the width of the second part 112 can be ensured, and the efficiency of acquisition of inductance can be ensured. Meanwhile, since the first angle θ1 is smaller than 80°, the length of the second part 112 can be increased, and the inductance can be improved.

On the other hand, in a case where the first angle θ1 is smaller than 45°, regions of the first part 111 and the third part 113 in the bent wiring 11b1 increase, the width of the second part 112 connecting the first part 111 and the third part 113 is extremely decreased, and risk of breakage of the second part 112 increases. In addition, a distance between the first penetration wirings 13 adjacent to each other in the axis AX direction and a distance between the second penetration wirings 14 adjacent to each other in the axis AX direction are increased, a coil length is increased, and the efficiency of acquisition of inductance deteriorates. In addition, a distance between the first penetration wiring 13 and the second penetration wiring 14 is shortened, a coil diameter is reduced, and the efficiency of acquisition of inductance deteriorates. Meanwhile, in a case where the first angle θ1 is larger than 80°, the first penetration wiring 13 and the second penetration wiring 14 are connected at a distance close to the shortest distance, and it is not possible to increase a length of the bottom surface wiring 11b.

According to the configuration described above, since the third angle θ3 is larger than 1°, the length of the second part 112 can be increased, and the inductance can be improved. Meanwhile, since the third angle θ3 is smaller than 45°, the width of the second part 112 can be ensured.

On the other hand, in a case where the third angle θ3 is 0°, that is, the first penetration wiring 13 and the second penetration wiring 14 are connected by the shortest distance, the straight wiring 11b2 is formed instead of the bent wiring 11b1, and it is not possible to increase the length of the bottom surface wiring 11b. Meanwhile, in a case where the third angle θ3 is larger than 45°, this means that the second part 112 is formed to be approximately parallel to the axis AX, a line width of the second part 112 is narrowed, and the breakage risk increases, similarly to the case where the first angle θ1 is smaller than 45°.

FIG. 4B is a schematic bottom view of the top surface wiring 11t from the bottom surface side. In FIG. 4B, for convenience, the first penetration wiring 13 and the second penetration wiring 14 are drawn by two-dot chain lines, and the element body 10 is drawn transparently.

As shown in FIG. 4B, the top surface wiring 11t extends only in one direction. To be more specific, the top surface wiring 11t extends in a direction in which the centers of both the first penetration wiring 13 and the second penetration wiring 14 connected to the same top surface wiring 11t are connected by a straight line. That is, the top surface wiring 11t has a shape extending in the Y direction. The bent wiring is not provided at the top surface wiring 11t. Hence, the length of the top surface wiring 11t can be easily shortened.

All the top surface wirings 11t are arranged parallel to each other in the X direction. According to the configuration described above, since the top surface wirings 11t extend only in one direction and all the top surface wirings 11t are arranged parallel to each other, it is possible to form the fine top surface wirings 11t and reduce the size of the inductor component 1 by using, for example, modified illumination in a photolithography process. Note that at least one top surface wiring 11t of all the top surface wirings 11t may have a shape extending in the Y direction.

The bottom surface wirings 11b and the top surface wirings 11t are made of a good conductor material such as copper, silver, gold, or an alloy thereof. The bottom surface wirings 11b and the top surface wirings 11t may be a metal film formed by plating, vapor deposition, sputtering, or the like, or may be a metal sintered body obtained by applying and sintering a conductor paste. In addition, the bottom surface wirings 11b and the top surface wirings 11t may have a multilayer structure in which a plurality of metal layers are layered. The bottom surface wirings 11b and the top surface wirings 11t have a thickness of preferably 5 μm or more and 50 μm or less (i.e., from 5 μm to 50 μm).

As shown in FIG. 1, the first penetration wirings 13 are disposed in through-holes V of the element body 10 on the first side surface 100s1 side with respect to the axis AX, and the second penetration wirings 14 are disposed in the other through-holes V of the element body 10 on the second side surface 100s2 side with respect to the axis AX. Each of the first penetration wirings 13 and the second penetration wirings 14 extends in a direction orthogonal to the bottom surface 100b and the top surface 100t. This enables lengths of the first penetration wirings 13 and the second penetration wirings 14 to be shortened, thus enabling the direct current resistance (Rdc) to be reduced. The first penetration wirings 13 and the second penetration wirings 14 are all arranged parallel to each other in the X direction.

Preferably, the first penetration wirings 13 contain SiO₂. This enables a linear expansion coefficient of the first penetration wiring 13 to be equal to a linear expansion coefficient of the element body 10 in a case where the element body 10 contains SiO₂, thus enabling cracks between the first penetration wirings 13 and the element body 10 to be reduced. The first penetration wiring 13 is made of, for example, a conductive paste. A conductive material is Ag, Cu, or the like. Similarly, the second penetration wirings 14 preferably contain SiO₂.

Preferably, at least one wiring of the bottom surface wirings 11b, the top surface wirings 11t, the first penetration wirings 13, and the second penetration wirings 14 includes a void portion or a resin portion. This enables stress due to a difference in linear expansion coefficient between the wiring and the element body 10 to be absorbed by the void portion or the resin portion, thus enabling the stress to be alleviated. As a method of forming the void portion, for example, the void portion can be formed by sintering a wiring, by using a member which is burned into the material of the wiring by being sintered. As a method for forming the resin portion, for example, the resin portion can be formed by using a conductive paste in the material of the wiring.

Preferably, at least one wiring of the bottom surface wirings 11b and the top surface wirings 11t contains SiO₂. This enables a linear expansion coefficient of the wiring to be equal to the linear expansion coefficient of the element body 10 in a case where the element body 10 contains SiO₂, thus enabling cracks between the wiring and the element body 10 to be reduced.

Preferably, the shape of the coil 110 has 180° rotational symmetry around a center of the coil 110 in the axis AX direction when viewed in the direction orthogonal to the bottom surface 100b. According to the configuration described above, directionality of the inductor component 1 can be eliminated.

### (First External Electrode 121 and Second External Electrode 122)

As shown in FIG. 1, the first external electrode 121 is connected to the first end portion of the coil 110, and the second external electrode 122 is connected to the second end portion of the coil 110. The first external electrode 121 is provided on the first end surface 100e1 side with respect to a center of the element body 10 in the X direction to be exposed from the outer surface 100 of the element body 10. The second external electrode 122 is provided on the second end surface 100e2 side with respect to a center of the element body 10 in the X direction to be exposed from the outer surface 100 of the element body 10.

When viewed in the direction orthogonal to the bottom surface 100b, the first external electrode 121 and the second external electrode 122 are positioned on an inner side with respect to the outer surface 100 of the element body 10. That is, the first external electrode 121 and the second external electrode 122 are positioned on an inner side with respect to the first end surface 100e1, the second end surface 100e2, the first side surface 100s1, and the second side surface 100s2 of the element body 10.

According to the configuration described above, since the first external electrode 121 and the second external electrode 122 are not in contact with the outer surfaces 100 of the element body 10, loads applied to the first external electrode 121 and the second external electrode 122 can be decreased, and deformation and peeling of the first external electrode 121 and the second external electrode 122 can be reduced, when division into individual inductor components is performed. Therefore, even if the inductor component has a small size, it is possible to prevent the first external electrode 121 and the second external electrode 122 from being deformed or peeled off.

Note that the first external electrode 121 may be provided to be continuously connected to the bottom surface 100b and the first end surface 100e1. This enables a solder fillet to be formed on the first external electrode 121 when the inductor component 1 is mounted on a mounting substrate, since the first external electrode 121 is a so-called L-shaped electrode. Similarly, the second external electrode 122 may be provided to be continuously connected to the bottom surface 100b and the second end surface 100e2.

The first external electrode 121 has a bottom surface part 121b provided on the bottom surface 100b and a via part 121v embedded in the bottom surface 100b. The via part 121v is connected to the bottom surface part 121b. The via part 121v is connected to an end portion of the bottom surface wiring 11b positioned on the first end surface 100e1 side in the axis AX direction.

The second external electrode 122 has a bottom surface part 122b provided on the bottom surface 100b and a via part 122v embedded in the bottom surface 100b. The via part 122v is connected to the bottom surface part 122b. The via part 122v is connected to an end portion of the bottom surface wiring 11b positioned on the second end surface 100e2 side in the axis AX direction.

As shown in FIG. 3, the first external electrode 121 has a base layer 121e1 and a plating layer 121e2 covering the base layer 121e1. The base layer 121e1 contains, for example, a conductive material such as Ag or Cu. The plating layer 121e2 contains, for example, a conductive material such as Ni or Sn. A part of the bottom surface part 121b and the via part 121v are formed by the base layer 121e1. The other part of the bottom surface part 121b is formed by the plating layer 121e2. Similarly, the second external electrode 122 has a base layer and a plating layer covering the base layer. Note that the first external electrode 121 and the second external electrode 122 may be made of a single-layer conductor material.

### (Method for Manufacturing Inductor Component 1)

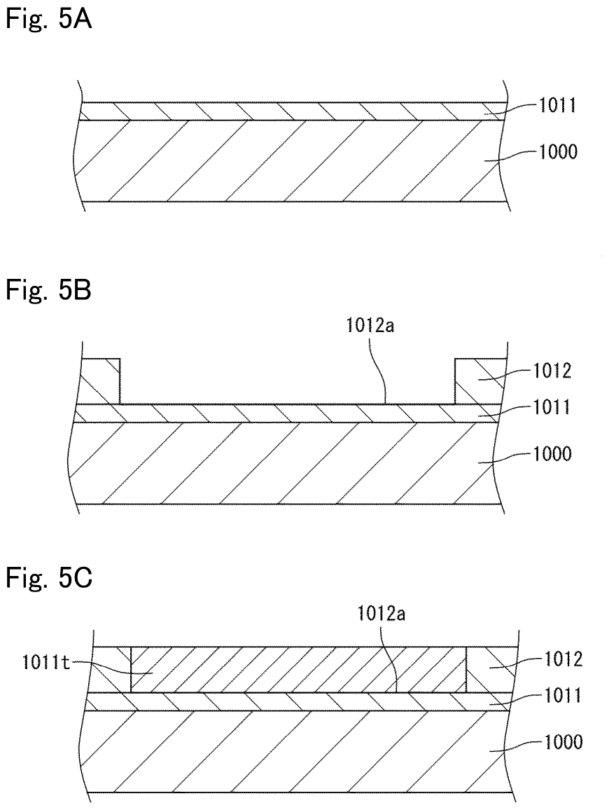

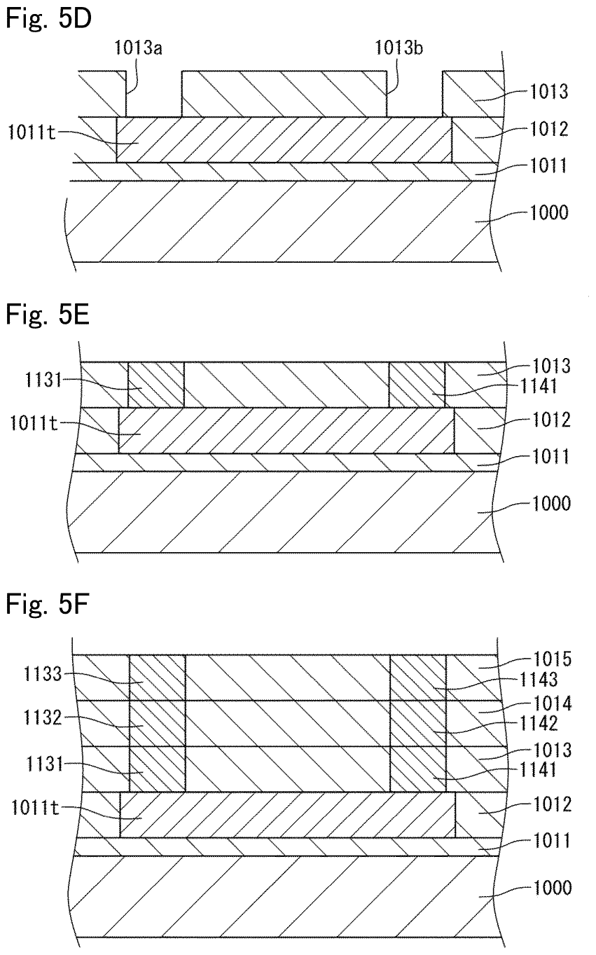

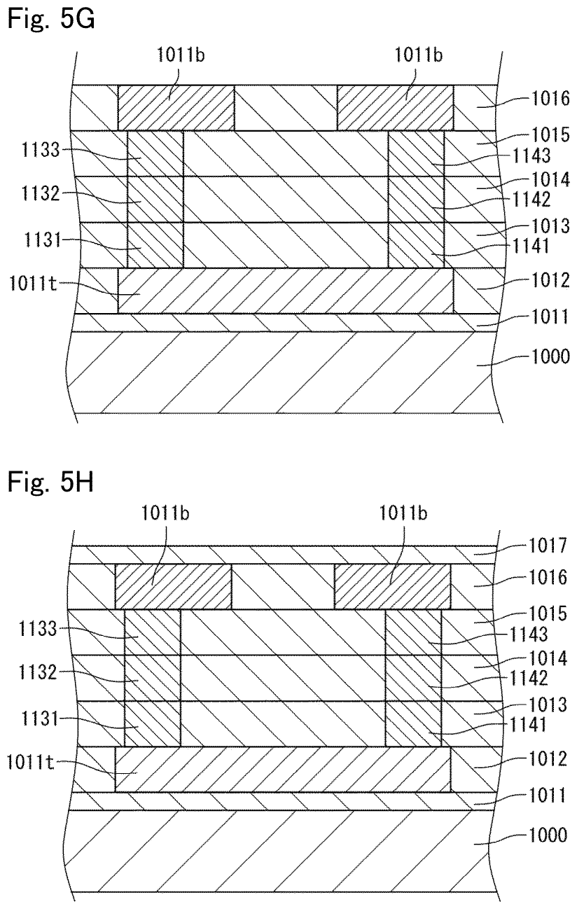

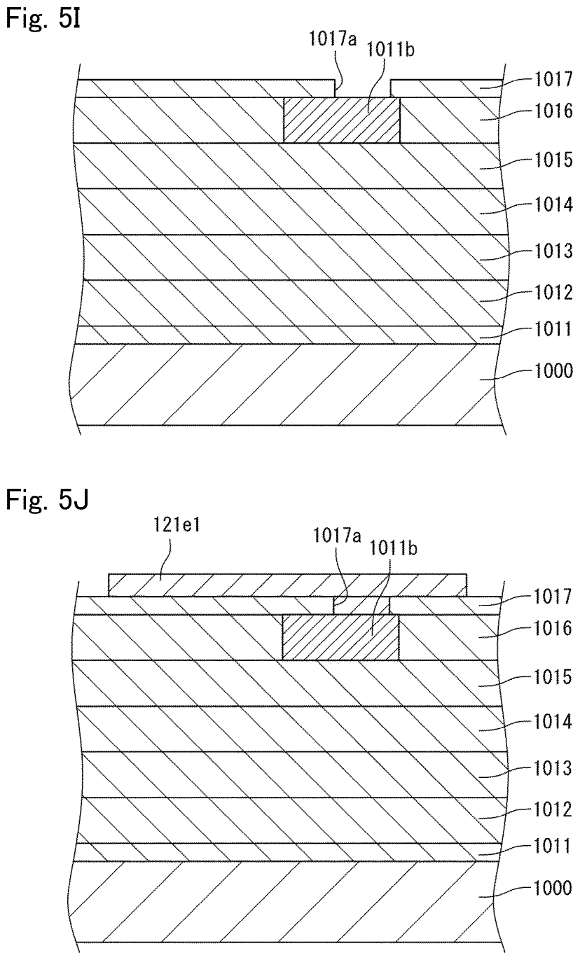

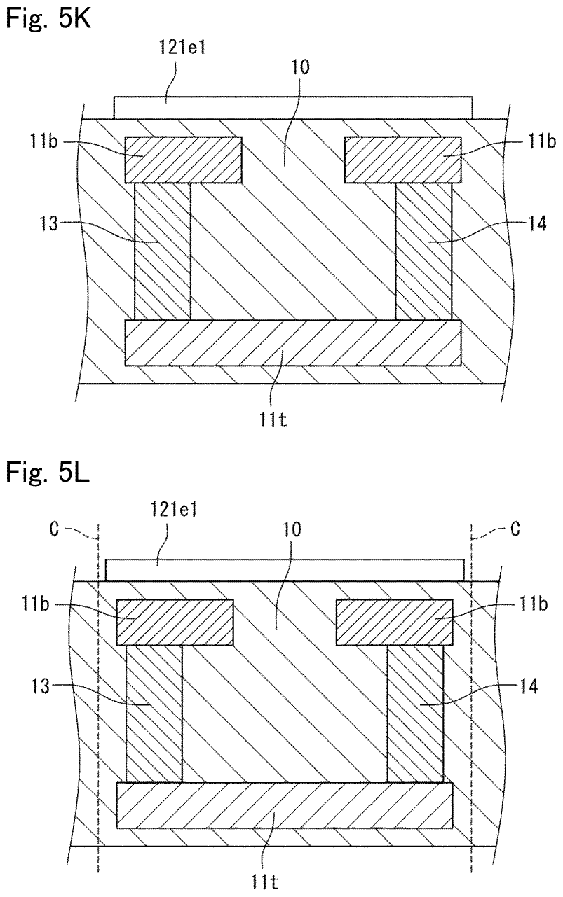

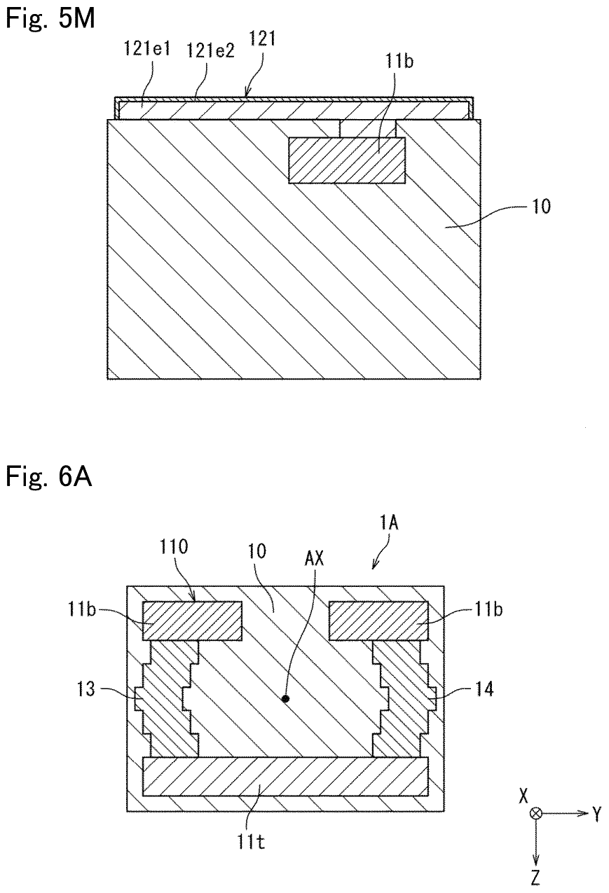

Next, a method for manufacturing the inductor component 1 will be described with reference to FIGS. 5A to 5M. FIGS. 5A to 5H, 5K, and 5L are views corresponding to a cross section taken along line II-II in FIG. 1. FIGS. 5I, 5J, and 5M are views corresponding to a cross section taken along line III-III in FIG. 1.

As shown in FIG. 5A, a first insulating layer 1011 is printed on a base substrate 1000. Examples of materials of the base substrate 1000 include a glass substrate, a silicon substrate, an alumina substrate, or the like, and examples of materials of the first insulating layer 1011 include a resin such as epoxy or polyimide, or an inorganic insulating film such as SiO or SiN.

As shown in FIG. 5B, a second insulating layer 1012 is printed on the first insulating layer 1011. A groove 1012a is provided in the second insulating layer 1012. In this case, for example, the groove 1012a is formed by the photolithography process. Note that the groove may be formed as a printed pattern from the beginning.

As shown in FIG. 5C, a top surface conductor layer 1011t is printed in the groove 1012a. Examples of materials of the top surface conductor layer 1011t include Ag, Cu, Au, Al, an alloy containing at least one of these elements, or a solder paste. In this case, for example, the top surface conductor layer 1011t is formed as a printed pattern to remain only in the groove 1012a. Note that, after the top surface conductor layer 1011t is printed on the second insulating layer 1012, the top surface conductor layer 1011t may remain only in the groove 1012a by the photolithography process.

As shown in FIG. 5D, a third insulating layer 1013 is printed on the second insulating layer 1012. The third insulating layer 1013 has a first groove 1013a and a second groove 1013b. The first groove 1013a and the second groove 1013b are formed in the same method as described in FIG. 5B.

As shown in FIG. 5E, a first penetration conductor layer 1131 as a first layer is printed in the first groove 1013a, and a second penetration conductor layer 1141 as the other first layer is printed in the second groove 1013b. The first penetration conductor layer 1131 as the first layer and the second penetration conductor layer 1141 as the other first layer are formed by the same method described in FIG. 5C.

By repeating the above-described processes, as shown in FIG. 5F, a fourth insulating layer 1014 is provided on the third insulating layer 1013, and a first penetration conductor layer 1132 as a second layer and a second penetration conductor layer 1142 as the other second layer are provided in two respective grooves provided in the fourth insulating layer 1014. Further, a fifth insulating layer 1015 is provided on the fourth insulating layer 1014, and a first penetration conductor layer 1133 as a third layer and a second penetration conductor layer 1143 as the other third layer are provided in two respective grooves provided in the fifth insulating layer 1015.

As shown in FIG. 5G, a sixth insulating layer 1016 is provided on the fifth insulating layer 1015, and a bottom surface conductor layer 1011b is provided in a groove provided in the sixth insulating layer 1016. A material of the bottom surface conductor layer 1011b is the same as the material of the top surface conductor layer 1011t. As shown in FIG. 5H, a seventh insulating layer 1017 is provided on the sixth insulating layer 1016.

As shown in FIG. 5I, a groove 1017a is provided in the seventh insulating layer 1017 such that a part of the bottom surface conductor layer 1011b is exposed. As shown in FIG. 5J, a base conductor layer 1121e1 is provided on the seventh insulating layer 1017 and in the groove 1017a. Examples of materials of the base conductor layer 1121e1 include resin pastes of Ag or Cu.

As shown in FIG. 5K, an entire layered body is sintered in a furnace at a high temperature (for example, 500° C. or higher). The first to seventh insulating layers 1011 to 1017 are sintered to form the element body 10, the top surface conductor layer 1011t is sintered to form the top surface wiring 11t, the bottom surface conductor layer 1011b is sintered to form the bottom surface wiring 11b, the first penetration conductor layers 1131 to 1133 as the first to third layers are sintered to form the first penetration wiring 13, the second penetration conductor layers 1141 to 1143 as the first to third other layers are sintered to form the second penetration wiring 14, and the base conductor layer 1121e1 is sintered to form the base layer 121e1. Hence, it is possible to improve the strength by sintering the insulating layers, and a resin component which does not need to be contained in the conductor layers can be volatilized by sintering the conductor layers, and a conductor material contained in the conductor layers can be fused to realize high conductivity. The base substrate 1000 may be peeled off by decomposing a surface during sintering, may be mechanically removed by performing grinding or the like before and after the sintering, or may be chemically removed by performing etching or the like before and after the sintering.

As shown in FIG. 5L, division into individual inductor components is performed along a cutting line C. As shown in FIG. 5M, the plating layer 121e2 is formed by performing barrel plating to cover the base layer 121e1, and the first external electrode 121 is formed. Consequently, as shown in FIG. 2, the inductor component 1 is manufactured.

### 3. MODIFICATION EXAMPLES

### First Modification Example

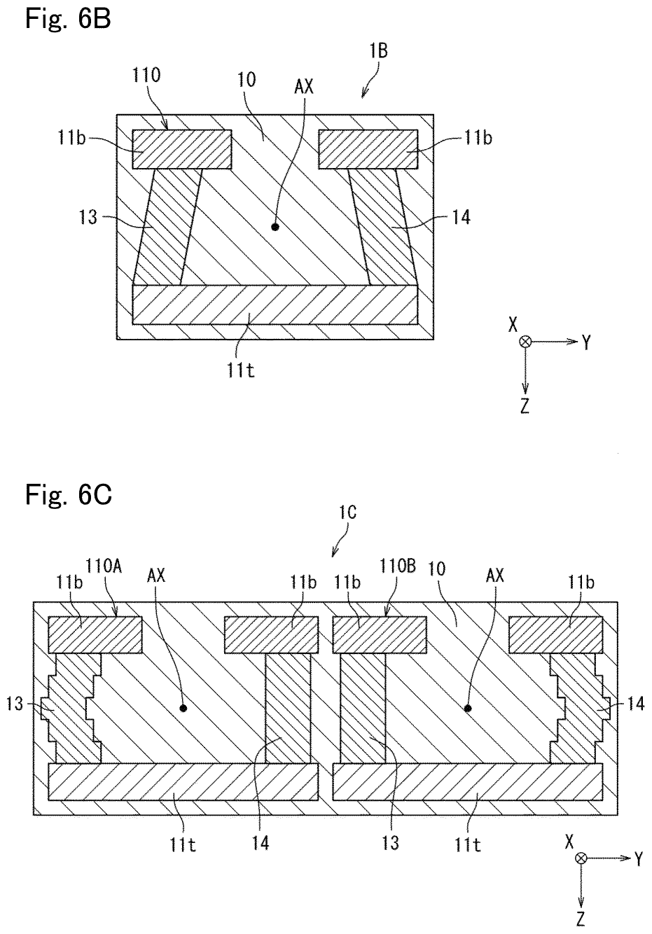

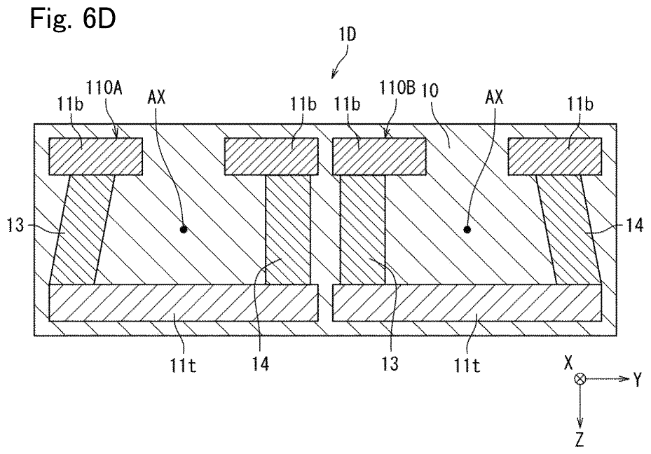

FIG. 6A is a view showing a first modification example of the inductor component, and the view corresponds to the cross section taken along line II-II in FIG. 1. As shown in FIG. 6A, in an inductor component 1A of the first modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wiring 13 and the second penetration wiring 14 are bent at respective centers thereof in the Z direction such that a space therebetween is widened toward the centers. That is, each of the first penetration wiring 13 and the second penetration wiring 14 has a shape expanding outward in a radial direction of the coil 110 toward the center in the Z direction. In addition, each of the first penetration wiring 13 and the second penetration wiring 14 has a stepped shape in the Z direction. According to the configuration described above, in a case where the first penetration wiring 13 and the second penetration wiring 14 are each formed by layering a plurality of conductor layers, the first penetration wiring 13 and the second penetration wiring 14 can be easily formed in the stepped shape by shifting and layering each conductor layer.

### Second Modification Example

FIG. 6B is a view showing a second modification example of the inductor component, and the view corresponds to the cross section taken along line II-II in FIG. 1. As shown in FIG. 6B, in an inductor component 1B of the second modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wirings 13 and the second penetration wirings 14 are inclined such that a space therebetween is widened toward the top surface wiring 11t side in the Z direction. That is, each of the first penetration wirings 13 and the second penetration wirings 14 has a shape expanding outward in the radial direction of the coil 110 toward the top surface wiring 11t in the Z direction. As described above, the coil 110 has a trapezoidal shape when viewed from the axis AX direction. According to the configuration described above, the first penetration wirings 13 and the second penetration wirings 14 can be linearly formed and shortened, and the DC resistance of the first penetration wirings 13 and the second penetration wirings 14 can be reduced.

### Third Modification Example

FIG. 6C is a view showing a third modification example of the inductor component, and the view corresponds to the cross section taken along line II-II in FIG. 1. As shown in FIG. 6C, an inductor component 1C of the third modification example includes a first coil 110A and a second coil 110B as compared with the inductor component 1A of the first modification example shown in FIG. 6A.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1A of the first modification example. Meanwhile, the second penetration wiring 14 has a linear shape parallel to the Z direction. That is, the first penetration wiring 13 is bent at a center thereof in the Z direction such that a space between the first penetration wiring 13 and the second penetration wiring 14 is widened toward the center. The first penetration wiring 13 has a stepped shape in the Z direction. According to the configuration described above, in a case where the first penetration wiring 13 is formed by layering a plurality of conductor layers, the first penetration wiring 13 can be easily formed in the stepped shape by shifting and layering each conductor layer.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1A of the first modification example. Meanwhile, the first penetration wiring 13 has a linear shape parallel to the Z direction. That is, the second penetration wiring 14 is bent at a center thereof in the Z direction such that a space between the first penetration wiring 13 and the second penetration wiring 14 is widened toward the center. The second penetration wiring 14 has a stepped shape in the Z direction. According to the configuration described above, in a case where the second penetration wiring 14 is formed by layering a plurality of conductor layers, the second penetration wiring 14 can be easily formed in the stepped shape by shifting and layering each conductor layer.

### Fourth Modification Example

FIG. 6D is a view showing a fourth modification example of the inductor component, and the view corresponds to the cross section taken along line II-II in FIG. 1. As shown in FIG. 6D, an inductor component 1D of the fourth modification example includes a first coil 110A and a second coil 110B as compared with the inductor component 1B of the second modification example shown in FIG. 6B.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1B of the second modification example. Meanwhile, the second penetration wiring 14 has a linear shape parallel to the Z direction. That is, the first penetration wiring 13 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed and shortened, and the DC resistance of the first penetration wirings 13 and the second penetration wirings 14 can be reduced.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1B of the second modification example. Meanwhile, the first penetration wiring 13 has a linear shape parallel to the Z direction. That is, the second penetration wiring 14 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed, and the electrical resistance of the first penetration wirings 13 and the second penetration wirings 14 can be reduced.

### Fifth Modification Example

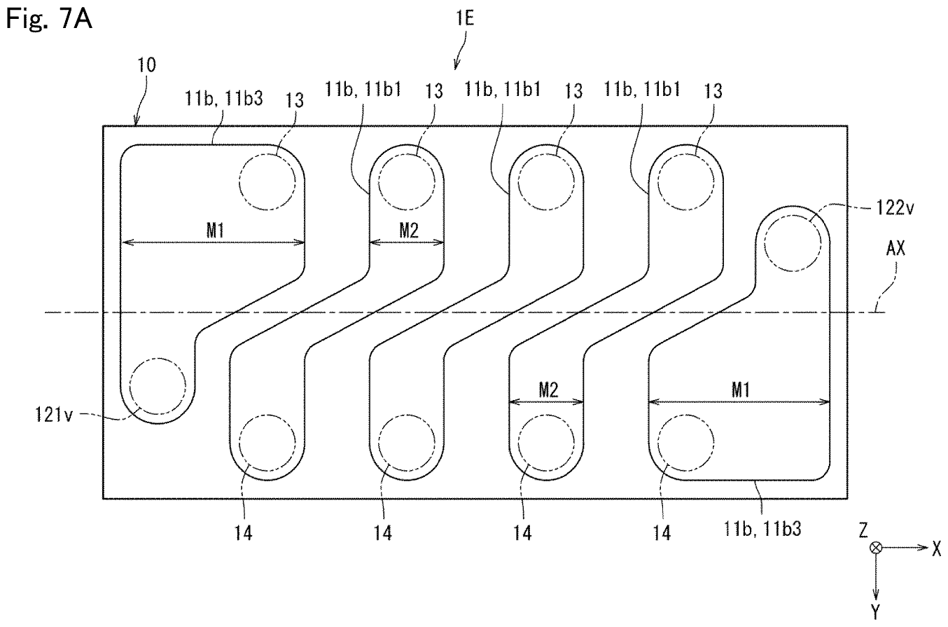

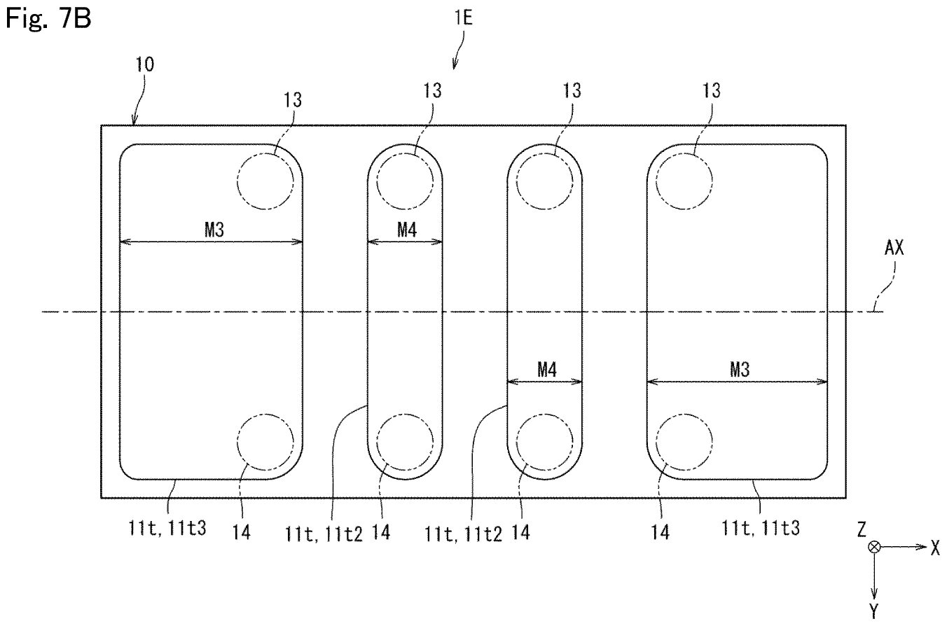

FIG. 7A is a schematic bottom view of a bottom surface wiring 11b from the bottom surface side according to a fifth modification example of the inductor component. In FIG. 7A, for convenience, the first penetration wirings 13 and the second penetration wirings 14 are drawn by two-dot chain lines, and a via part 121v of the first external electrode 121 connected to the bottom surface wiring 11b and a via part 122v of the second external electrode 122 connected to the bottom surface wiring 11b are drawn by two-dot chain lines. In addition, the element body 10 is drawn transparently.

As shown in FIG. 7A, in an inductor component 1E of the fifth modification example, among the plurality of bottom surface wirings 11b, the bottom surface wiring 11b at the outermost end positioned on the outermost side in the axis AX direction is not a bent wiring but a wide wiring 11b3. The bottom surface wirings 11b positioned between the wide wirings 11b3 at both ends are bent wirings 11b1.
when viewed in the direction orthogonal to the bottom surface 100b, a maximum length M1 of the wide wiring 11b3 in the axis AX direction is larger than a maximum length M2 in the axis AX direction of the bottom surface wiring 11b (bent wiring 11b1) adjacent to the wide wiring 11b3 in the axis AX direction.

According to the configuration described above, a width of the bottom surface wiring 11b at the outermost end can be increased such that the DC resistance of the coil can be reduced. In addition, the width of the bottom surface wiring 11b at the outermost end can be increased by effectively utilizing a dead space in an outermost region of the coil in the axis AX direction in the element body.

FIG. 7B is a schematic bottom view of a top surface wiring 11t from the bottom surface side according to the fifth modification example of the inductor component. In FIG. 7B, for convenience, the first penetration wiring 13 and the second penetration wiring 14 are drawn by two-dot chain lines, and the element body 10 is drawn transparently.

As shown in FIG. 7B, among a plurality of top surface wirings 11t, the top surface wiring 11t at the outermost end positioned on the outermost side in the axis AX direction is a wide wiring 11t3. The top surface wirings 11t positioned between the wide wirings 11t3 at both ends are straight wirings 11t2.
when viewed in the direction orthogonal to the bottom surface 100b, a maximum length M3 of the wide wiring 11t3 in the axis AX direction is larger than a maximum length M4 in the axis AX direction of the top surface wiring 11t (straight wiring 11t2) adjacent to the wide wiring 11t3 in the axis AX direction.

According to the configuration described above, a width of the top surface wiring 11t at the outermost end can be increased such that the DC resistance of the coil can be reduced. In addition, the width of the top surface wiring 11t at the outermost end can be increased by effectively utilizing a dead space in an outermost region of the coil in the axis AX direction in the element body.

Note that the bent wirings may be provided at least on as the bottom surface wirings 11b, or may be provided as both the bottom surface wirings 11b and the top surface wirings 11t.

### Second Embodiment

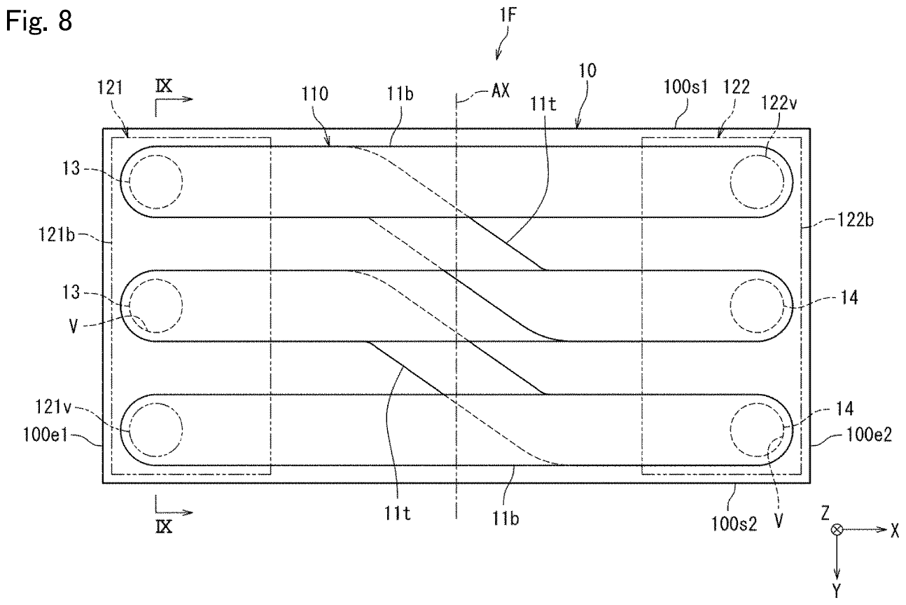

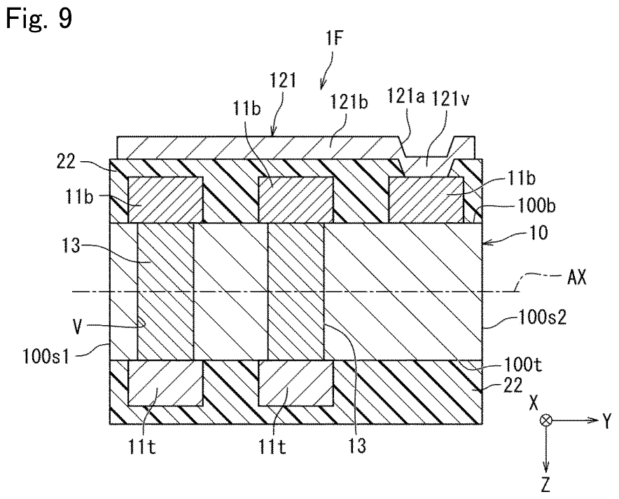

FIG. 8 shows a schematic bottom view of a second embodiment of the inductor component from a bottom surface side. FIG. 9 is a cross-sectional view taken along line IX-IX in FIG. 8. In FIG. 8, for convenience, an insulating layer is omitted, and the external electrodes are drawn by two-dot chain lines. In addition, in FIG. 8, the element body 10 is drawn transparently so that a structure thereof can be easily understood. The second embodiment differs from the first embodiment mainly in the shape of the coil, the position of the axis of the coil, the material of the element body, and providing of an insulating layer, and these different configurations will be mainly described below. The other configurations are the same as those of the first embodiment, and the description thereof will be omitted.

### 1. CONFIGURATIONS OF RESPECTIVE UNITS

### (Inductor Component 1F)

As shown in FIG. 8, in an inductor component 1F, an axis AX of a coil 110 is perpendicular to the X direction. To be more specific, the axis AX is parallel to the Y direction and passes a center of the element body 10 in the X direction. This enables interference in magnetic flux of the coil 110 by the first external electrode 121 and the second external electrode 122 to be reduced, and it is possible to improve the efficiency of acquisition of inductance.

A length of the coil 110 in the axis AX direction is shorter than an inner diameter of the coil 110. The length of the coil 110 in the axis AX direction is also referred to as a coil length. This enables the Q value to be improved since the coil length is short and the coil inner diameter is large. The inner diameter of the coil indicates an equivalent circle diameter based on a minimum area of a region surrounded by the coil 110 when viewed therethrough in the axis AX direction.

### (Element Body 10)

The element body 10 is an inorganic insulating body. The material of the element body 10 is preferably glass, and this enables an eddy current to be reduced and enables the Q value to be increased since the glass has high insulation properties. The element body 10 preferably contains an Si element, and this enables the thermal stability of the element body 10 to be increased, thus, enabling variations in dimension or the like of the element body 10 due to heat to be reduced and enabling variations in electrical characteristics to be decreased.

The element body 10 is preferably a single-layer glass plate. This enables the strength of the element body 10 to be ensured. In addition, in the case of the single-layer glass plate, since dielectric loss is small, the Q value at a high frequency can be increased. In addition, since no sintering process for such a sintered body is performed, deformation of the element body 10 during sintering can be reduced. Hence, it is possible to reduce pattern misalignment and provide an inductor component with a small inductance tolerance.

As a material of the single-layer glass plate, a glass plate having photosensitivity represented by Foturan II (Schott AG's registered trademark) is preferable from the viewpoint of a manufacturing method. In particular, the single-layer glass plate preferably contains cerium oxide (ceria: CeO₂), and in this case, cerium oxide serves as a sensitizer, and processing by photolithography becomes easier.

However, since the single-layer glass plate can be processed by machining such as drilling or sandblasting, dry/wet etching using a photoresist/metal mask, laser processing, or the like, the single-layer glass plate may be a non-photosensitive glass plate. In addition, the single-layer glass plate may be obtained by sintering a glass paste, or may be formed by a known method such as a float process.

### (Insulating Body 22)

As shown in FIG. 9, the inductor component 1F includes an insulating body 22. The insulating body 22 covers both the bottom surface 100b and the top surface 100t of the element body 10. Note that the insulating body 22 may be provided only on the bottom surface 100b of the bottom and top surfaces 100b and 1100t.

The insulating body 22 is a member that protects the wirings from an external force by covering the wirings (the bottom surface wirings 11b and the top surface wirings 11t), and has a role of preventing the wirings from being damage and a role of improving insulation properties of the wirings. The insulating body 22 is preferably an organic insulating body. For example, the insulating body 22 may be a film made of a resin such as epoxy or polyimide which is easily formed. In particular, the insulating body 22 is preferably made of a material having a low dielectric constant. Consequently, in a case where the insulating body 22 is present between the coil 110 and the external electrode 121 or 122, it is possible to decrease the stray capacitance formed between the coil 110 and the external electrode 121 or 122. The insulating body 22 can be formed, for example, by laminating a resin film such as ABF GX-92 (manufactured by Ajinomoto Fine-Techno Co., Inc.), applying and thermal-curing a paste-like resin, or the like. Note that the insulating body 22 may be, for example, an inorganic film made of an oxide such as silicon or hafnium, a nitride, an oxynitride, or the like, which is excellent in insulating properties and thinning.

Preferably, when the element body 10 is the inorganic insulating body, and the insulating body 22 is an organic insulating body, the organic insulating body is positioned on an inner side with respect to the outer surfaces 100 of the inorganic insulating body when viewed in the direction orthogonal to the bottom surface 100b. According to this, since the organic insulating body is provided and easily imparts flowability, and thus is easily filled into a space between wirings adjacent to each other and enables insulating properties to be improved, in a case where the wirings (the bottom surface wirings 11b and the top surface wirings 11t) are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

### (Coil 110)

As shown in FIG. 8, all the bottom surface wirings 11b are arranged parallel to each other in the Y direction. The bottom surface wirings 11b extend only in one direction. That is, the bottom surface wirings 11b have a shape extending in the X direction. To be more specific, one bottom surface wiring 11b of both ends in the axis AX direction has a first end portion connected to the via part 121v of the first external electrode 121 and a second end portion connected to the second penetration wiring 14. The one bottom surface wiring 11b extends in a direction in which the first end portion and the second end portion are connected by a straight line when viewed in the direction orthogonal to the bottom surface 100b.

The other bottom surface wiring 11b of both ends in the axis AX direction has a first end portion connected to the via part 122v of the second external electrode 122 and a second end portion connected to the first penetration wiring 13. The other bottom surface wiring 11b extends in a direction in which the first end portion and the second end portion are connected by a straight line when viewed in the direction orthogonal to the bottom surface 100b.

The rest of the other bottom surface wirings 11b has a first end portion connected to the first penetration wiring 13 and a second end portion connected to the second penetration wiring 14. The rest of the other bottom surface wirings 11b extends in a direction in which the first end portion and the second end portion are connected by a straight line when viewed in the direction orthogonal to the bottom surface 100b.

As described above, the bottom surface wirings 11b are not the bent wirings but the straight wirings. Hence, a length of the bottom surface wiring 11b can be easily shortened.

The first penetration wirings 13 are disposed in the through-holes V of the element body 10 on the first end surface 100e1 side with respect to the axis AX, and the second penetration wirings 14 are disposed in the other through-holes V of the element body 10 on the second end surface 100e2 side with respect to the axis AX. Each of the first penetration wirings 13 and the second penetration wirings 14 extends in a direction orthogonal to the bottom surface 100b and the top surface 100t. The plurality of first penetration wirings 13 and the plurality of second penetration wirings 14 are all arranged parallel to each other in the Y direction.

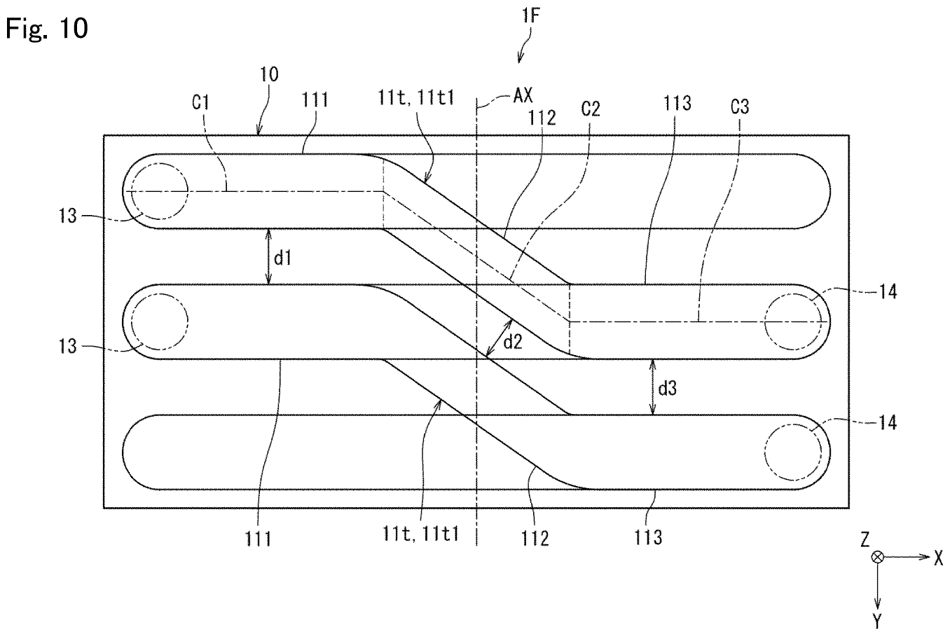

FIG. 10 is a schematic bottom view of the top surface wirings 11t from the bottom surface side. In FIG. 10, for convenience, the first penetration wiring 13 and the second penetration wiring 14 are drawn by two-dot chain lines, and the element body 10 is drawn transparently.

As shown in FIG. 10, the plurality of top surface wirings 11t are arranged in the Y direction. The top surface wiring 11t is a bent wiring 11t1. The bent wiring 11t1 has a first part 111, a second part 112, and a third part 113. The first part 111, the second part 112, and the third part 113 are connected in series in this order.

The bent wiring 11t1 (the first part 111, the second part 112, and the third part 113) of the top surface wiring 11t has the same configuration as that the bent wiring 11b1 (the first part 111, the second part 112, and the third part 113) of the bottom surface wiring 11b described in the first embodiment, and has the same effects. Hereinafter, the bent wiring 11t1 of the top surface wiring 11t will be described, but the detailed configuration (definitions and the like) thereof is the same as that of the bent wiring 11b1 of the bottom surface wiring 11b described in the first embodiment, and thus the description thereof will be omitted.

When viewed in the direction orthogonal to the bottom surface 100b, an angle of the first part 111 with respect to the axis AX is different from an angle β of the second part 112 with respect to the axis AX. When viewed in the direction orthogonal to the bottom surface 100b, an angle γ of the third part 113 with respect to the axis AX is different from the angle β of the second part 112 with respect to the axis AX. According to the configuration described above, a length of the bent wiring 11t1 can be easily increased.

Preferably, in the two bent wirings 11t1 adjacent to each other in the axis AX direction, when viewed in the direction orthogonal to the bottom surface 100b, a second distance d2 between a second part 112 of one bent wiring 11t1 and a second part 112 of the other bent wiring 11t1 is smaller than a first distance d1 between a first part 111 of one bent wiring 11t1 and a first part 111 of the other bent wiring 11t1. According to the configuration described above, since the second distance d2 is short, it is possible to reduce leakage flux. Similarly, the second distance d2 is preferably smaller than a third distance d3 between a third part 113 of one bent wiring 11t1 and a third part 113 of the other bent wiring 11t1.

Preferably, when viewed in the direction orthogonal to the bottom surface 100b, a length of the first part 111 is smaller than a half of a width of the element body 10 in a direction (X direction) orthogonal to the axis AX. The length of the first part 111 is a length of the first center line C1 of the first part 111. According to the configuration described above, it is possible to reduce a likelihood that two bent wirings 11t1 adjacent to each other in the axis AX direction will come into contact with each other. Similarly, a length of the third part 113 is preferably smaller than a half of the width of the element body 10 in the direction orthogonal to the axis AX.

Preferably, when viewed in the direction orthogonal to the bottom surface 100b, a width of the second part 112 in a direction orthogonal to the second center line C2 is 0.5 times or more and 0.95 times or less (i.e., from 0.5 times to 0.95 times) of a width of the first part 111 in a direction orthogonal to the first center line C1. According to the configuration described above, since the width of the second part 112 is 0.95 times or less of the width of the first part 111, the width of the second part 112 can be decreased, and this enables a length of the second part 112 to be increased so that the inductance can be increased. Meanwhile, since the width of the second part 112 is 0.5 times or more of the width of the first part 111, breakage of the second part 112 can be prevented. Similarly, when viewed in the direction orthogonal to the bottom surface 100b, preferably, the width of the second part 112 in the direction orthogonal to the second center line C2 is 0.5 times or more and 0.95 times or less (i.e., from 0.5 times to 0.95 times) of the width of the third part 113 in a direction orthogonal to the third center line C3.

Preferably, when viewed in the direction orthogonal to the bottom surface 100b, a first length of the bent wiring 11t1 between centers of both the first penetration wiring 13 and the second penetration wiring 14 connected to the bent wiring 11t1 is longer by 4% or more of a second length obtained by connecting centers of both the first penetration wiring 13 and the second penetration wiring 14 connected to the same bent wiring 11t1 by a straight line. The first length is a length between the centers of both the first penetration wiring 13 and the second penetration wiring 14 of lengths of center lines (the first center line C1, the second center line C2, and the third center line C3) of the bent wiring 11t1. According to the configuration described above, since the length of the bent wiring 11t1 can be increased, the inductance can be increased.

Preferably, when viewed in the direction orthogonal to the bottom surface 100b, an angle of the second part 112 (second center line C2) with respect to the axis AX is set to a first angle, and an angle of a straight line connecting centers of both the first penetration wiring 13 and the second penetration wiring 14 connected to the bent wiring 11t1 having the same second part 112, with respect to the axis AX, is set to a second angle. In this case, the second angle is larger than the first angle. The first angle is larger than 45° and smaller than 80° (i.e., from larger than 45° to smaller than) 80°. A third angle, which is a difference between the second angle and the first angle, is larger than 1° and smaller than 45° (i.e., from larger than 1° to smaller than) 45°.

According to the configuration described above, since the first angle is larger than 45°, the width of the second part 112 can be ensured, and the efficiency of acquisition of inductance can be ensured. Since the first angle is smaller than 80°, the length of the second part 112 can be increased, and the inductance can be improved. Since the third angle is larger than 1°, the length of the second part 112 can be increased, and the inductance can be improved. Meanwhile, since the third angle is smaller than 45°, a width of the second part 112 can be ensured.

### (First External Electrode 121 and Second External Electrode 122)

As shown in FIG. 9, an outer surface of the first external electrode 121 has a recessed portion 121a. The recessed portion 121a is provided at a position overlapping the via part 121v on an upper surface of the first external electrode 121 when viewed in the direction orthogonal to the bottom surface 100b. This allows solder to enter the recessed portion 121a of the first external electrode 121, and allows the connection strength between the first external electrode 121 and the solder to be improved, in a case where the inductor component 1F is mounted on a substrate.

Similarly, an outer surface of the second external electrode 122 may have a recessed portion. This allows solder to enter the recessed portion of the second external electrode 122, and allows the connection strength between the second external electrode 122 and the solder to be improved, in a case where the inductor component 1F is mounted on a substrate. Note that the first external electrode 121 and the second external electrode 122 may be formed to have flat upper surfaces, respectively.

### (Method for Manufacturing Inductor Component 1F)

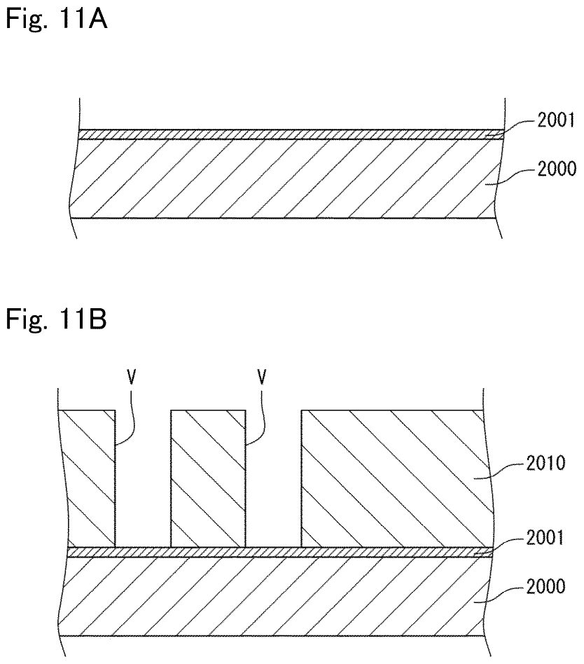

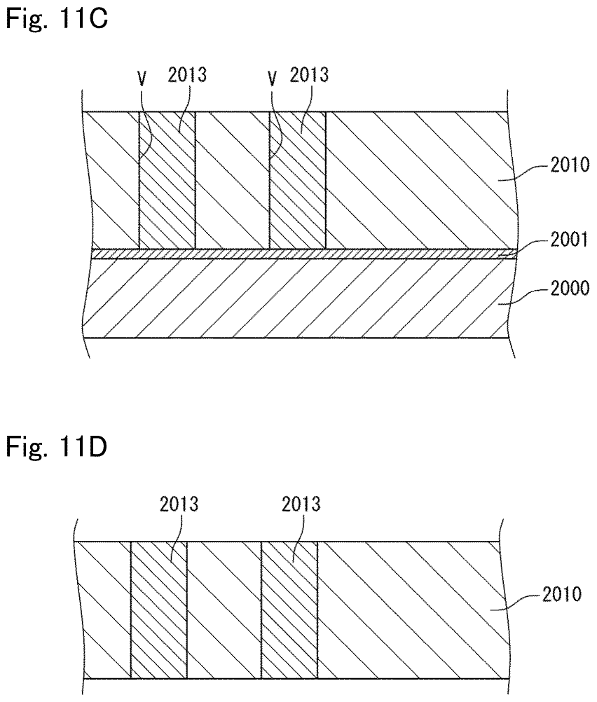

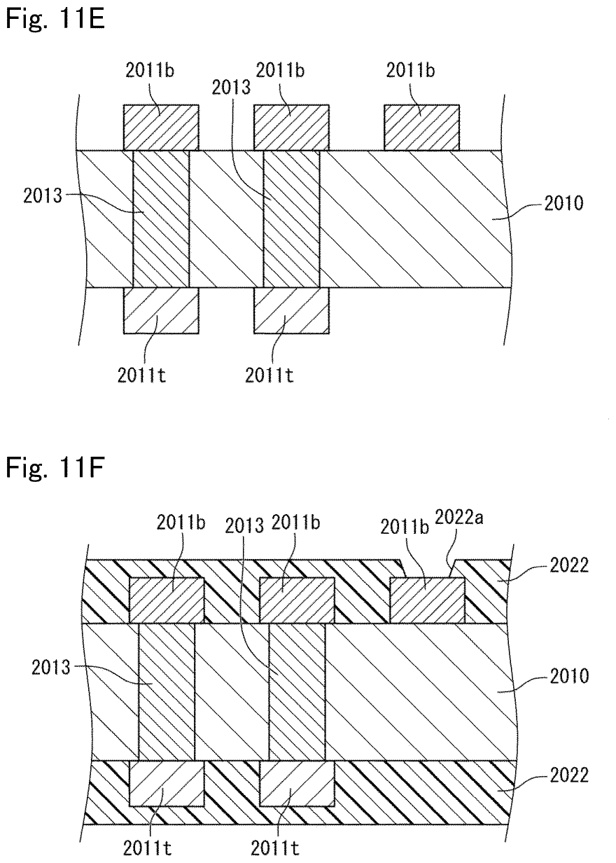

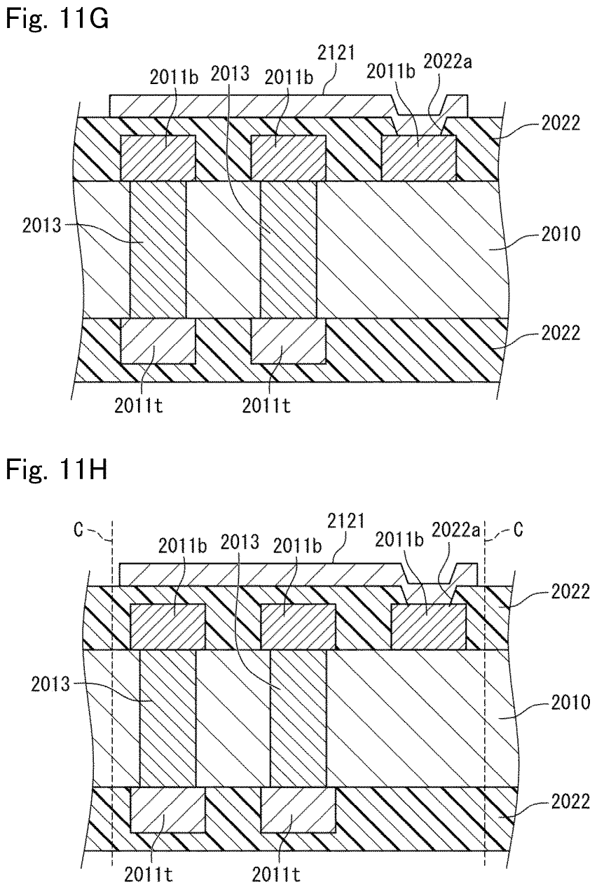

Next, a method for manufacturing the inductor component 1F will be described with reference to FIGS. 11A to 11H. FIGS. 11A to 11H are views corresponding to a cross section taken along line IX-IX in FIG. 8.

As shown in FIG. 11A, copper foil 2001 is printed on a base substrate 2000. A material of the base substrate 2000 is the same as that of the base substrate 1000 of the first embodiment.

As shown in FIG. 11B, a glass substrate 2010 which becomes the element body 10 is provided on the base substrate 2000. For example, the base substrate 2000 and the glass substrate 2010 are brought into close contact with each other using a jig such as a conductive tape, a pin, or a frame. The glass substrate 2010 has a through-hole V. The glass substrate 2010 is, for example, a through glass via (TGV) substrate. The TGV substrate is a substrate in which a through-hole is formed in advance by a laser, photolithography, or the like. The glass substrate 2010 may be, for example, a through silicon via (TSV) substrate, or may be another substrate. In addition, Ti/Cu or other necessary conductive materials may be deposited on a surface of the glass substrate 2010 in advance as seeds by sputtering or the like.

As shown in FIG. 11C, a first penetration conductor layer 2013 which becomes the first penetration wiring 13 is formed in the through-hole V of the glass substrate 2010. Although not shown, similarly, a second penetration conductor layer which becomes the second penetration wiring 14 is formed in the through-hole V. To be more specific, by supplying electric power from the copper foil 2001 on the base substrate 2000, electrolytic plating is performed on the through-hole V of the glass substrate 2010 to form the first penetration conductor layer 2013. Otherwise, a seed layer may be formed on the surface of the glass substrate 2010 or an inner surface of the through-hole V by sputtering or the like, and the penetration conductor layer may be formed by using a known method such as fill plating, conformal plating, or a printing filling method of a conductive paste. In a case where there is unnecessary plating growth on the surface of the glass substrate 2010, an unnecessary part is removed by polishing, CMP, wet etching (etchback), or dry etching.

As shown in FIG. 11D, the base substrate 2000 is peeled off from the glass substrate 2010. In this case, the base substrate 2000 may be mechanically removed by grinding or the like, or may be chemically removed by etching or the like.

As shown in FIG. 11E, a bottom surface conductor layer 2011b which becomes the bottom surface wiring 11b and a top surface conductor layer 2011t which becomes the top surface wiring 11t are formed on the glass substrate 2010. To be more specific, a seed layer (not shown) is provided on the entire surface of the glass substrate 2010, and patterned photoresist is formed on the seed layer. A copper layer is formed on the seed layer in an opening portion of the photoresist by electrolytic plating. The photoresist and the seed layer are removed by wet etching or dry etching. Consequently, the bottom surface conductor layer 2011b and the top surface conductor layer 2011t patterned in an arbitrary shape are formed. In this case, the bottom surface conductor layer 2011b and the top surface conductor layer 2011t may be formed one by one, or may be formed simultaneously.

As shown in FIG. 11F, an insulating layer 2022 serving as the insulating body 22 is provided on a top surface and a bottom surface of the glass substrate 2010 to cover the conductor layer. In this case, the insulating layer 2022 on the bottom surface side and the insulating layer 2022 on the top surface side may be formed one by one, or may be formed simultaneously. Thereafter, a hole 2022a is formed in the bottom surface conductor layer 2011b of the insulating layer 2022 on the bottom surface side by photolithography or laser processing.

As shown in FIG. 11G, a first external electrode conductor layer 2121 which becomes the first external electrode 121 is provided on the insulating layer 2022 on the bottom surface side. In this case, the first external electrode conductor layer 2121 is connected to the bottom surface conductor layer 2011b via the hole 2022a. To be more specific, a Pd catalyst (not shown) is provided on the insulating layer 2022 on the bottom surface side, and an Ni/Au plated layer is formed by electroless plating. Patterned photoresist is formed on the plating layer. A plating layer in an opening portion of the photoresist is removed by wet etching or dry etching. Consequently, the first external electrode conductor layer 2121 patterned in an arbitrary shape is formed. Alternatively, a seed layer (not shown) is provided on the insulating layer 2022 on the bottom surface side, and the patterned photoresist is formed on the seed layer. Next, the seed layer in the opening portion of the photoresist is removed by wet etching or dry etching. An Ni/Au plating layer may be formed on the remaining seed layer by electroless plating. Although not shown, a second external electrode conductor layer which becomes the second external electrode 122 is provided on the insulating layer 2022 on the bottom surface side.

Here, since the first external electrode conductor layer 2121 is formed to conform to a shape of an upper surface of the insulating layer 2022 on the bottom surface side, an upper surface of the first external electrode conductor layer 2121 has a recessed portion in a region overlapping the hole 2022a.

As shown in FIG. 11H, division into individual components is performed along the cutting line C. Consequently, as shown in FIG. 9, the inductor component 1F is manufactured.

### 2. MODIFICATION EXAMPLES

### First Modification Example

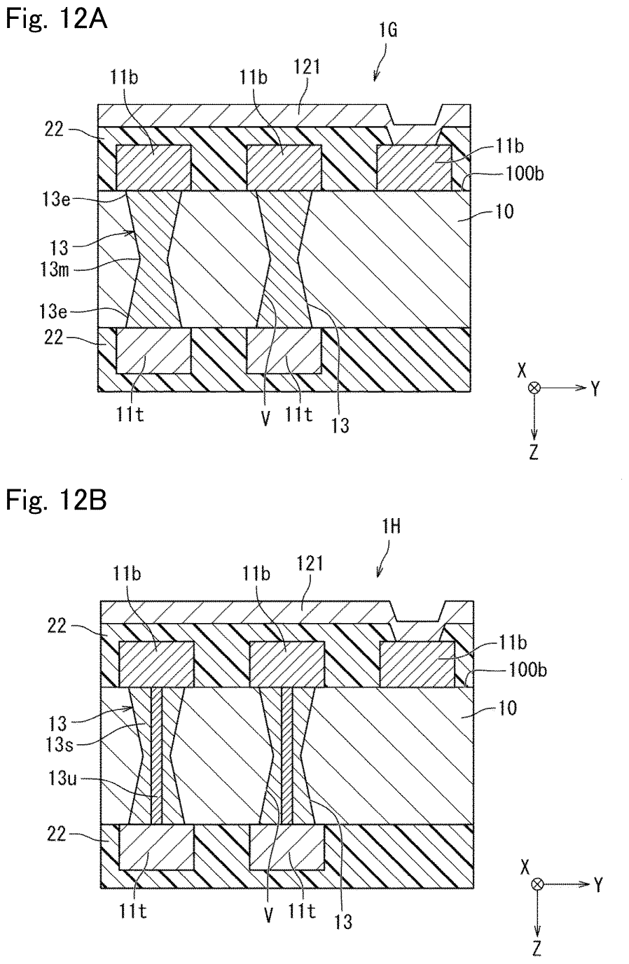

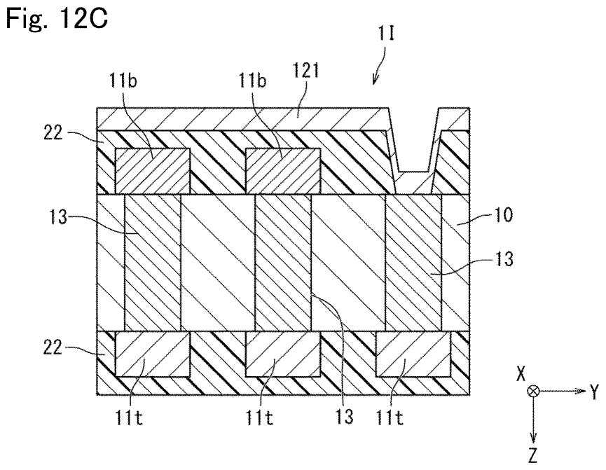

FIG. 12A is a view showing a first modification example of the inductor component, and the view corresponds to the cross section taken along line IX-IX in FIG. 8. As shown in FIG. 12A, in an inductor component 1G of the first modification example, the first penetration wiring 13 extends in a direction orthogonal to the bottom surface wiring 11b, and a cross-sectional area of each of both end portions 13e of the first penetration wiring 13 in an extending direction thereof is larger than a cross-sectional area of a central portion 13m of the first penetration wiring 13 in the extending direction. That is, in a cross section of the first penetration wiring 13 in the extending direction, a width of the first penetration wiring 13 in a direction orthogonal to the extending direction continuously increases from the central portion 13m toward both the end portions 13e.

This enables the cross-sectional area of the end portion 13e of the first penetration wiring 13 to be increased, so that the connectivity between the first penetration wiring 13 and at least one of the bottom surface wiring 11b and the top surface wiring 11t can be improved. In addition, when the through-hole V is formed as a hole portion in the element body 10, the through-hole V is filled with a conductive material by fill plating or the like, and the first penetration wiring 13 is formed in the through-hole V, it is easy to fill the through-hole V on an opening side with the conductive material. Since the cross-sectional area of the end portion 13e of the first penetration wiring 13 is large, and the cross-sectional area of the central portion 13m of the first penetration wiring 13 is small, the first penetration wiring 13 is easily formed.

Note that the cross-sectional area of one end portion 13e of the first penetration wiring 13 may be larger than the cross-sectional area of the central portion 13m of the first penetration wiring 13. Similarly, the cross-sectional area of at least one end portion of the second penetration wiring 14 may be larger than the cross-sectional area of the central portion 13m of the first penetration wiring 13.

### Second Modification Example

FIG. 12B is a view showing a second modification example of the inductor component, and the view corresponds to the cross section taken along line IX-IX in FIG. 8. As shown in FIG. 12B, in an inductor component 1H of the second modification example, the first penetration wiring 13 includes a conductive layer 13s positioned on an outer circumferential side thereof when viewed from an extending direction of the first penetration wiring 13, and a non-conductive layer 13u positioned inside the conductive layer 13s. This prevents the Q value from being reduced by providing the conductive layer 13s on the outer circumferential side since a current mainly flows in a surface of the first penetration wiring 13 due to a skin effect in the case of use in a high frequency band. In addition, by providing the non-conductive layer 13u inside, stress can be alleviated, and manufacturing costs can be reduced by using no conductor.

An example of a method of forming the conductive layer 13s and the non-conductive layer 13u will be described. A seed layer is provided on the inner surface of the through-hole V of the element body 10 by sputtering or electroless plating. A plating layer is formed on the seed layer by electrolytic plating. In this manner, for example, a plurality of conductive layers 13s of Ti/Cu/electrolytic Cu, Pd/electroless Cu/electrolytic Cu, or the like can be formed on the first penetration wiring 13 on the outer circumferential side thereof. Thereafter, the inside of the conductive layer 13s is sealed with a resin by printing, hot pressing, or the like to form the non-conductive layer 13u made of a resin. In this manner, stress can be alleviated by the non-conductive layer 13u inside the first penetration wiring 13 while a current flows in the surface (the conductive layer 13s) of the first penetration wiring 13.

Similarly, the second penetration wiring 14 may include a conductive layer positioned on an outer circumferential side thereof when viewed from an extending direction of the second penetration wiring 14, and a non-conductive layer positioned inside the conductive layer. Note that a cross-sectional area of each of both end portions of the first penetration wiring 13 in the extending direction is larger than a cross-sectional area of a central portion of the first penetration wiring 13 in the extending direction, but the cross-sectional area of each of both the end portions of the first penetration wiring 13 in the extending direction may be the same as the cross-sectional area of the central portion of the first penetration wiring 13 in the extending direction.

### Third Modification Example

FIG. 12C is a view showing a third modification example of the inductor component, and the view corresponds to the cross section taken along line IX-IX in FIG. 8. As shown in FIG. 12C, in an inductor component 1I of the third modification example, the first external electrode 121 is not connected to the bottom surface wiring 11b but is connected to the first penetration wiring 13 on the rightmost side in FIG. 12C. That is, a first end portion of the corresponding first penetration wiring 13 is connected to the first external electrode 121, and a second end portion of the corresponding first penetration wiring 13 is connected to the top surface wiring 11t on the rightmost side in FIG. 12C. This enables the coil 110 to be easily connected to the first external electrode 121 even when the number of turns of the coil 110 is changed.

Similarly, although not shown, the second external electrode 122 is not connected to the bottom surface wiring 11b but is connected to the second penetration wiring 14 on the leftmost side in FIG. 12C. That is, a first end portion of the corresponding second penetration wiring 14 is connected to the second external electrode 122, and a second end portion of the corresponding second penetration wiring 14 is connected to the top surface wiring 11t on the rightmost side in FIG. 12C.

The number of the bottom surface wirings 11b is smaller than the number of the top surface wirings 11t, and two bottom surface wirings 11b and three top surface wirings 11t are provided. The bottom surface wirings 11b are the bent wirings, and the top surface wirings 11t are the straight wirings.

### Third Embodiment

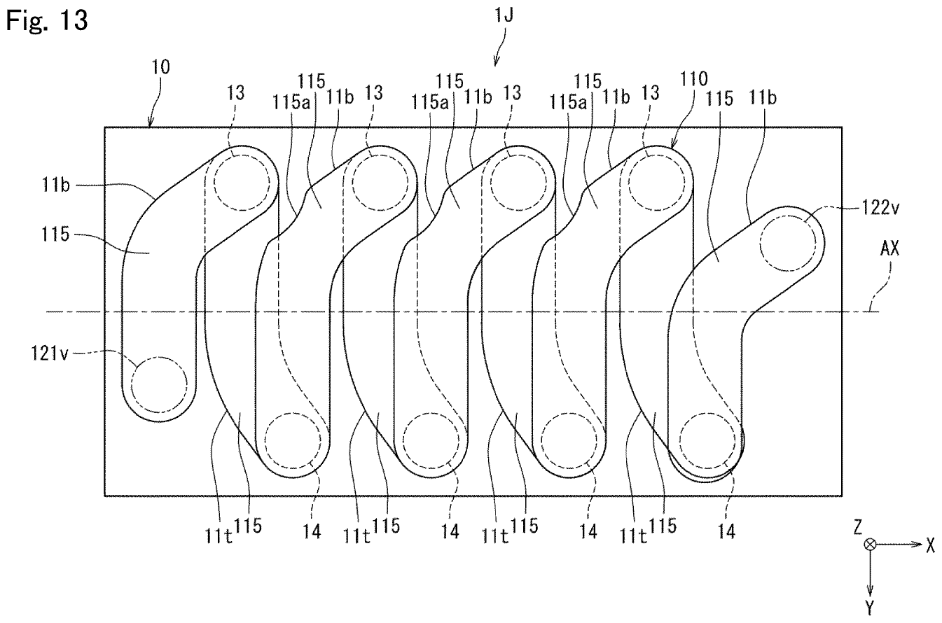

FIG. 13 is a schematic bottom view of a third embodiment of the inductor component from the bottom surface side. In FIG. 13, an external electrode is drawn by a two-dot chain line for convenience. In addition, in FIG. 13, the element body 10 is drawn transparently so that a structure thereof can be easily understood. The third embodiment differs from the first embodiment in that the bottom surface wiring and the top surface wiring have different shapes from each other, and these different configurations will be described below. The other configurations are the same as those of the first embodiment, and the description thereof will be omitted.

As shown in FIG. 13, in an inductor component 1J according to the third embodiment, when viewed in a direction (Z direction) orthogonal to the bottom surface 100b, all the bottom surface wirings 11b and all the top surface wirings 11t are bent wirings having respective curved parts 115. To be more specific, each of the bent wirings includes a curved part 115 and a straight part. The straight part is positioned at each of both ends of the bent wiring, and the curved part 115 is positioned between the straight parts at both ends. The straight parts at both ends have different angles from each other with respect to the axis AX.

According to the configuration described above, since the bottom surface wirings 11b and the top surface wirings 11t are the bent wirings, a length of the wirings of the coil 110 can be changed without changing a size of the inductor component 1J such that the inductance can be easily adjusted. Note that at least one of the plurality of bottom surface wirings 11b and the plurality of top surface wirings 11t may be a bent wiring having the curved part 115.

Preferably, a plurality of bent wirings are present, and all the curved parts 115 of the bent wirings are curved to project toward one side in the axial direction when viewed in the direction orthogonal to the bottom surface 100b. According to the configuration described above, a magnetic field in a reverse direction is not generated in all the curved parts 115, and the efficiency of acquisition of the inductor can be increased.

Preferably, a side surface of the curved part 115 of the bottom surface wiring 11b has a recess 115a when viewed in the direction orthogonal to the bottom surface 100b. The recess 115a is provided in the side surface of the curved part 115 on a projecting side. The recess 115a is provided at a position opposite to a first penetration wiring 13 connected to a bottom surface wiring 11b adjacent to the corresponding bottom surface wiring 11b in the axis AX direction. According to the configuration described above, since the side surface of the curved part 115 has the recess 115a, a width of the curved part 115 can be decreased such that it is possible to decrease a likelihood that two bent wirings adjacent to each other in the axial direction will come into contact with each other. Note that a side surface of a curved part 115 of the top surface wiring 11t may have a recess 115a.

Preferably, the bent wiring is made of only the curved part 115. According to the configuration described above, since the bent wiring does not have a straight part, it is possible to further increase the length of the coil 110. Note that at least one of the plurality of bent wirings may be made of only the curved part 115.

Note that curvature radii of all the curved parts 115 may be the same, or the curvature radii of at least two curved parts 115 may be different from each other. In addition, one curved part 115 may have a plurality of different radii of curvature. In this case, the radii of curvature may change continuously or stepwise.

### Fourth Embodiment

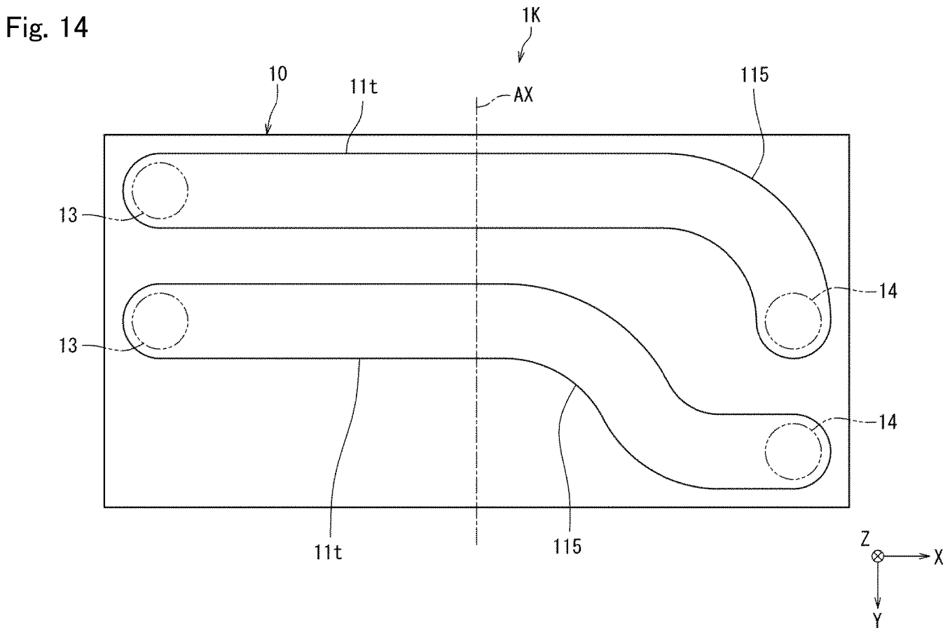

FIG. 14 is a schematic bottom view of a fourth embodiment of the inductor component from the bottom surface side. FIG. 14 shows a view of the top surface wiring 11t from the bottom surface side. In FIG. 14, for convenience, the first penetration wiring 13 and the second penetration wiring 14 are drawn by two-dot chain lines, and the element body 10 is drawn transparently. The fourth embodiment differs from the second embodiment in FIG. 10 in that the top surface wirings have a different shape, and these different configurations will be described below. The other configurations are the same as those of the second embodiment, and the description thereof will be omitted.

As shown in FIG. 14, in an inductor component 1K according to the fourth embodiment, when viewed in a direction (Z direction) orthogonal to the bottom surface 100b, all the top surface wirings 11t are bent wirings having respective curved parts 115.

To be more specific, the top surface wiring 11t on one side (the upper side in FIG. 14) in the axis AX direction includes the curved part 115 and a straight part. The straight part is positioned at an end portion of the top surface wiring 11t on the first penetration wiring 13 side. The curved part 115 is positioned at an end portion of the top surface wiring 11t on the second penetration wiring 14 side. The curved part 115 is curved to project upward in FIG. 14.

The top surface wiring 11t on the other side (the lower side in FIG. 14) in the axis AX direction includes the curved part 115 and straight parts. The straight parts are positioned at an end portion of the top surface wiring 11t on the first penetration wiring 13 side and at an end portion of the top surface wiring 11t on the second penetration wiring 14 side. The curved part 115 is positioned between the straight parts at both ends. The curved part 115 is curved in a meandering manner.

According to the configuration described above, since the top surface wirings 11t are the bent wirings, a length of the wirings of the coil 110 can be changed without changing a size of the inductor component 1K such that the inductance can be easily adjusted. Note that at least one of the plurality of bottom surface wirings 11b and the plurality of top surface wirings 11t may be a bent wiring having the curved part 115.

Preferably, similarly to the third embodiment, a plurality of bent wirings are present, and all the curved parts 115 of the bent wirings are curved to project toward one side in the axial direction when viewed in the direction orthogonal to the bottom surface 100b. According to the configuration described above, a magnetic field in a reverse direction is not generated in all the curved parts 115, and the efficiency of acquisition of the inductor can be increased.

Preferably, similarly to the third embodiment, a side surface of the curved part 115 has a recess when viewed in the direction orthogonal to the bottom surface 100b. According to the configuration described above, since the side surface of the curved part 115 has the recess, a width of the curved part 115 can be decreased such that it is possible to decrease a likelihood that two bent wirings adjacent to each other in the axial direction will come into contact with each other.

Preferably, similarly to the third embodiment, the bent wiring is made of only the curved part 115. According to the configuration described above, since the bent wiring does not have a straight part, it is possible to further increase the length of the coil 110. Note that at least one of the plurality of bent wirings may be made of only the curved part 115.

Note that the present disclosure is not limited to the embodiments described above, and can be modified in design without departing from the gist of the present disclosure. For example, the individual characteristic points of the first to fourth embodiments may be variously combined. For example, two or more kinds of bent wirings of all the first to fourth embodiments may be mixed.

The present disclosure includes the following aspects.

<1> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order, and at least one of the plurality of first coil wirings and the plurality of second coil wirings is a bent wiring including a first part and a second part having different angles from each other with respect to the axis when viewed in a direction orthogonal to the first principal surface.

<2> The inductor component according to <1>, in which the first part is a part orthogonal to the axis or a part parallel to the axis, and the second part is a part intersecting the axis at an acute angle, when viewed in the direction orthogonal to the first principal surface.

<3> The inductor component according to <1> or <2>, in which the element body contains SiO₂.

<4> The inductor component according to any one of <1> to <3>, in which, in the two bent wirings adjacent to each other in the axial direction, a distance between the second part of one of the bent wirings and the second part of the other of the bent wirings is smaller than a distance between the first part of one of the bent wirings and the first part of the other of the bent wirings, when viewed in the direction orthogonal to the first principal surface.

<5> The inductor component according to any one of <1> to <4>, in which the bent wirings are provided in at least the first coil wirings, and at least one second coil wiring of the plurality of second coil wirings extends in a direction in which centers of each of the first penetration wirings and each of the second penetration wirings connected to the same second coil wiring are connected by a straight line when viewed in the direction orthogonal to the first principal surface.

<6> The inductor component according to any one of <1> to <5>, in which the bent wirings are provided in at least the first coil wirings, one first coil wiring of the plurality of first coil wirings has a first end portion connected to the first external electrode and a second end portion connected to the first penetration wiring, and the one first coil wiring extends in a direction in which the first end portion and the second end portion are connected by a straight line when viewed in the direction orthogonal to the first principal surface.

<7> The inductor component according to any one of <1> to <6>, in which the first part is a part orthogonal to the axis when viewed in the direction orthogonal to the first principal surface, and a length of the first part is smaller than a half of a width of the element body in a direction orthogonal to the axis when viewed in the direction orthogonal to the first principal surface.

<8> The inductor component according to any one of <1> to <7>, in which the first part is a part orthogonal to the axis, and the second part is a part intersecting the axis at an acute angle, when viewed in the direction orthogonal to the first principal surface, and a width of the second part is 0.5 times or more and 0.95 times or less (i.e., from 0.5 times to 0.95 times) of a width of the first part when viewed in the direction orthogonal to the first principal surface.

<9> The inductor component according to any one of <1> to <8>, in which the coil has a shape with 180° rotational symmetry around a center of the coil in an axial direction when viewed in the direction orthogonal to the first principal surface.

<10> The inductor component according to any one of <1> to <9>, in which a length of each of the bent wirings between centers of each of the first penetration wirings and each of the second penetration wirings connected to each of the bent wirings is longer by 4% or more of a length obtained by connecting centers of each of the first penetration wirings and each of the second penetration wirings connected to the same bent wiring by a straight line, when viewed in the direction orthogonal to the first principal surface.

<11> The inductor component according to any one of <1> to <10>, in which the first part is a part orthogonal to the axis, and the second part is a part intersecting the axis at an acute angle, when viewed in the direction orthogonal to the first principal surface. Also, when an angle of the second part with respect to the axis is defined as a first angle θ1, and with respect to the axis, an angle of a straight line connecting centers of each of the first penetration wirings and each of the second penetration wirings connected to each of the bent wirings having the same second part is defined as a second angle θ2. In addition, when viewed in the direction orthogonal to the first principal surface, the second angle θ2 is larger than the first angle θ1, the first angle θ1 is larger than 45° and smaller than 80° (i.e., from larger than 45° to smaller than) 80°, and a difference between the second angle θ2 and the first angle θ1 is larger than 1° and smaller than 45° (i.e., from larger than 1° to smaller than) 45°.

<12> The inductor component according to any one of <1> to <11>, in which the bent wirings are provided in at least the first coil wirings, an outermost first coil wiring positioned on an outermost side in the axial direction of the plurality of first coil wirings is not one of the bent wirings, and a maximum length in the axial direction of the outermost first coil wiring is larger than a maximum length in the axial direction of one of the first coil wirings which is adjacent to the outermost first coil wiring in the axial direction when viewed in the direction orthogonal to the first principal surface.

<13> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, at least one of the plurality of first coil wirings and the plurality of second coil wirings is a bent wiring including a curved part, when viewed in a direction orthogonal to the first principal surface.

<14> The inductor component according to <13>, in which a plurality of the bent wirings are present, and all the curved parts are curved to project toward one side in the axial direction when viewed in the direction orthogonal to the first principal surface.

<15> The inductor component according to <13> or <14>, in which a side surface of each of the curved parts has a recess when viewed from the direction orthogonal to the first principal surface.

<16> The inductor component according to any one of <13> to <15>, in which the bent wirings have only the respective curved parts.

What is claimed is:

1. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, in which
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
at least one of the plurality of first coil wirings and the plurality of second coil wirings is a bent wiring including a first part and a second part having different angles from each other with respect to the axis when viewed in a direction orthogonal to the first principal surface.

2. The inductor component according to claim 1, wherein
the first part is a part orthogonal to the axis or a part parallel to the axis, and the second part is a part intersecting the axis at an acute angle, when viewed in the direction orthogonal to the first principal surface.

3. The inductor component according to claim 1, wherein
the element body includes SiO₂.

4. The inductor component according to claim 1, wherein
in the two bent wirings adjacent to each other in the axial direction, a distance between the second part of one of the bent wirings and the second part of the other of the bent wirings is smaller than a distance between the first part of one of the bent wirings and the first part of the other of the bent wirings, when viewed in the direction orthogonal to the first principal surface.

5. The inductor component according to claim 1, wherein
the bent wirings are in at least the first coil wirings, and
at least one second coil wiring of the plurality of second coil wirings extends in a direction in which centers of each of the first penetration wirings and each of the second penetration wirings connected to the same second coil wiring are connected by a straight line when viewed in the direction orthogonal to the first principal surface.

6. The inductor component according to claim 1, wherein
the bent wirings are in at least the first coil wirings,
one first coil wiring of the plurality of first coil wirings has a first end portion connected to the first external electrode and a second end portion connected to the first penetration wiring, and
the one first coil wiring extends in a direction in which the first end portion and the second end portion are connected by a straight line when viewed in the direction orthogonal to the first principal surface.

7. The inductor component according to claim 1, wherein
the first part is a part orthogonal to the axis when viewed in the direction orthogonal to the first principal surface, and
a length of the first part is smaller than a half of a width of the element body in a direction orthogonal to the axis when viewed in the direction orthogonal to the first principal surface.

8. The inductor component according to claim 1, wherein
the first part is a part orthogonal to the axis, and the second part is a part intersecting the axis at an acute angle, when viewed in the direction orthogonal to the first principal surface, and
a width of the second part is from 0.5 times to 0.95 times of a width of the first part when viewed in the direction orthogonal to the first principal surface.

9. The inductor component according to claim 1, wherein
the coil has a shape with 180° rotational symmetry around a center of the coil in an axial direction when viewed in the direction orthogonal to the first principal surface.

10. The inductor component according to claim 1, wherein
a length of each of the bent wirings between centers of each of the first penetration wirings and each of the second penetration wirings connected to each of the bent wirings is longer by 4% or more of a length obtained by connecting centers of each of the first penetration wirings and each of the second penetration wirings connected to the same bent wiring by a straight line, when viewed in the direction orthogonal to the first principal surface.

11. The inductor component according to claim 1, wherein
the first part is a part orthogonal to the axis, and the second part is a part intersecting the axis at an acute angle, when viewed in the direction orthogonal to the first principal surface, and
when an angle of the second part with respect to the axis is defined as a first angle θ1, and with respect to the axis, an angle of a straight line connecting centers of each of the first penetration wirings and each of the second penetration wirings connected to each of the bent wirings having the same second part is defined as a second angle θ2, when viewed in the direction orthogonal to the first principal surface, the second angle θ2 is larger than the first angle θ1, the first angle θ1 is from larger than 45° to smaller than 80°, and a difference between the second angle θ2 and the first angle θ1 is from larger than 1° to smaller than 45°.

12. The inductor component according to claim 1, wherein
the bent wirings are in at least the first coil wirings,
an outermost first coil wiring positioned on an outermost side in the axial direction of the plurality of first coil wirings is not one of the bent wirings, and
a maximum length in the axial direction of the outermost first coil wiring is larger than a maximum length in the axial direction of one of the first coil wirings which is adjacent to the outermost first coil wiring in the axial direction when viewed in the direction orthogonal to the first principal surface.

13. The inductor component according to claim 2, wherein
the element body includes SiO₂.

14. The inductor component according to claim 2, wherein
in the two bent wirings adjacent to each other in the axial direction, a distance between the second part of one of the bent wirings and the second part of the other of the bent wirings is smaller than a distance between the first part of one of the bent wirings and the first part of the other of the bent wirings, when viewed in the direction orthogonal to the first principal surface.

15. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, in which
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
at least one of the plurality of first coil wirings and the plurality of second coil wirings is a bent wiring including a curved part, when viewed in a direction orthogonal to the first principal surface.

16. The inductor component according to claim 15, wherein
a plurality of the bent wirings are present, and
all the curved parts are curved to project toward one side in the axial direction when viewed in the direction orthogonal to the first principal surface.

17. The inductor component according to claim 15, wherein
a side surface of each of the curved parts has a recess when viewed from the direction orthogonal to the first principal surface.

18. The inductor component according to claim 15, wherein
the bent wirings have only the respective curved parts.

19. The inductor component according to claim 16, wherein
a side surface of each of the curved parts has a recess when viewed from the direction orthogonal to the first principal surface.

20. The inductor component according to claim 16, wherein
the bent wirings have only the respective curved parts.
